(19) United States
(12) Patent Application Publication
(10) Pub. No.: US 2025/0274727 A1
(43) Pub. Date: Aug. 28, 2025

(54) METHOD AND APPARATUS FOR GROUP MESSAGE MODIFICATION AND CANCEL

(71) Applicant: Telefonaktiebolaget LM Ericsson (publ), Stockholm (SE)

(72) Inventors: Jie LING, Shanghai (CN); Juying GAN, Shanghai (CN); Thorsten LOHMAR, Aachen (DE); Shabnam SULTANA, Montreal (CA)

(21) Appl. No.: 18/858,115

(22) PCT Filed: Apr. 26, 2023
(86) PCT No.: PCT/CN2023/090860

§ 371 Date: Oct. 18, 2024

(30) Foreign Application Priority Data
Apr. 29, 2022 (WO) PCT/CN2022/090425

(51) Int. Cl. H04W 4/08

(52) U.S. Cl. CPC H04W 4/08

(57) ABSTRACT

Embodiments of the present disclosure provide methods and apparatuses for group message modification and cancel. A method performed by an exposure node includes receiving a group message request from an application node. When the group message request is for a modification of group message delivery and includes group message payload, the method further includes transforming the group message payload into a file. The method further includes sending the file to a second broadcast multicast node.

### TECHNICAL FIELD

The non-limiting and exemplary embodiments of the present disclosure generally relate to the technical field of communications, and specifically to methods and apparatuses for group message modification and cancel.

### BACKGROUND

This section introduces aspects that may facilitate a better understanding of the disclosure. Accordingly, the statements of this section are to be read in this light and are not to be understood as admissions about what is in the prior art or what is not in the prior art.

Third Generation Partnership Project (3GPP) TS 23.247 V17.2.0, the disclosure of which is incorporated by reference herein in its entirety, describes architectural enhancements for 5G (fifth generation) multicast-broadcast services. 3GPP TS 23.682 V17.2.0, the disclosure of which is incorporated by reference herein in its entirety, describes group message delivery procedures. 3GPP TS 23.246 V16.1.0, the disclosure of which is incorporated by reference herein in its entirety, describes Multimedia Broadcast/Multicast Service (MBMS), architecture and functional description.

FIG. 1A shows an example of delivery methods, which is same as FIGS. 4.1-1 of 3GPP TS 23.247 V17.2.0.

Multicast and Broadcast Service (MBS) is a point-to-multipoint service in which data is transmitted from a single source entity to multiple recipients, either to all users in a broadcast service area, or to users in a multicast group. The corresponding types of MBS session are broadcast session and multicast session.

The MBS architecture follows the fifth generation (5G) System architectural principles as defined in 3GPP TS 23.501 V17.1.1, the disclosure of which is incorporated by reference herein in its entirety, enabling distribution of the MBS data from the 5GS (5G system) ingress to NG-RAN (next generation radio access network) node(s) and then to the UE (user equipment). The MBS architecture provides efficient usage of RAN (radio access network) and CN (core network) resources, with an emphasis on radio interface efficiency, and efficient transport for a variety of multicast and broadcast services.

The MBS also provides functionalities such as local MBS service, authorization of multicast MBS and QoS (quality of service) differentiation. MBS traffic is delivered from a single data source (e.g. Application Service Provider) to multiple UEs.

Depending on many factors, there are several delivery methods which may be used to deliver the MBS traffic in the 5GS (5G system).

Between 5GC (5G core network) and NG-RAN (next generation RAN), there are two possible delivery methods to transmit the MBS data.

The first delivery method is 5GC Individual MBS traffic delivery method. This method is only applied for multicast MBS session. 5GC receives a single copy of MBS data packets and delivers separate copies of those MBS data packets to individual UEs via per-UE PDU session. Hence for each such UE one PDU session is required to be associated with a multicast session.

The second delivery method is 5GC is shared MBS traffic delivery method. This method is applied for both broadcast and multicast MBS session. 5GC receives a single copy of MBS data packets and delivers a single copy of those MBS packets to an NG-RAN node, which then delivers the packets to one or multiple UEs.

The 5GC Shared MBS traffic delivery method is required in all MBS deployments. The 5GC Individual MBS traffic delivery method is required to enable mobility when there is an NG-RAN deployment with non-homogeneous support of MBS.

For the multicast session, a single copy of MBS data packets received by the CN (core network) may be delivered via 5GC Individual MBS traffic delivery method for some UE(s) and via 5GC Shared MBS traffic delivery method for other UEs.

Between the NG-RAN and the UE, two delivery methods are available for the transmission of MBS data packets over radio interface.

The first delivery method is Point-to-Point (PTP) delivery method where NG-RAN delivers separate copies of MBS data packets over radio interface to individual UE(s).

The second delivery method is Point-to-Multipoint (PTM) delivery method where NG-RAN delivers a single copy of MBS data packets over radio interface to multiple UEs.

NG-RAN may use a combination of PTP/PTM to deliver MBS data packets to UEs.

As depicted in FIG. 1A, 5GC Shared MBS traffic delivery method (with PTP or PTM delivery) and 5GC Individual MBS traffic delivery method may be used at the same time for a multicast MBS session.

For MBS broadcast communication, only 5GC Shared MBS traffic delivery method with PTM delivery is applicable.

For MBS multicast communication, if the NG-RAN node supports MBS, the network shall use the 5GC Shared MBS traffic delivery method for MBS data transmission.

For MBS multicast communication, the switching between 5GC Shared MBS traffic delivery method and 5GC Individual MBS traffic delivery method is supported. The UE mobility between RAN nodes both supporting MBS, and between a RAN node supporting MBS and a RAN node not supporting MBS is supported.

For MBS multicast communication, the switching between PTP and PTM delivery methods for 5GC Shared MBS traffic delivery shall be supported. NG-RAN is the decision point for switching between PTP and PTM delivery methods.

The term Temporary Mobile Group Identity (TMGI) is defined in 3GPP TS 23.003 V17.2.0, the disclosure of which is incorporated by reference herein in its entirety, and is used to be able to identify a broadcast MBS Session or a multicast MBS Session.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems in the exiting group message modification and cancel solution. According to 3GPP TS 23.682 V17.2.0, Services Capability Server (SCS)/Application Server (AS) sends a modify group message request to Service Capability Exposure Function (SCEF) and SCEF is expected to be able to modify or cancel the group message delivery to UE using MBMS. When modify a group message delivery, after SCEF invokes Modify MBMS Bearer procedure to BM-SC to replace the previous group message with the new one. The Modify MBMS Bearer procedure can only be used to update MBMS service area and Allocation and Retention Priority (ARP), but not the content delivered within the MBMS session. And SCEF cannot use Update Session Properties BM-SC to replace the group message with the new one as the xMB interface offered by BM-SC does not support group message directly.

In clause 8.8.1 of 3GPP 23.246 v16.1.0, MBMS session update procedure is specified as below: “The BM-SC uses the procedure to update the service area or the QoS (ARP) for an ongoing MBMS Broadcast service session.”

In clause 5.1.2.4 of 3GPP TS 23.468 V17.0.0, the disclosure of which is incorporated by reference herein in its entirety, Modify MBMS Bearer procedure is specified as below: “The Modify MBMS Bearer procedure is used by the GCS AS to cause modification of the priority and preemption values for an MBMS bearer, the MBMS broadcast area, or both.”

According to clause 5.4.4 of 3GPP TS 26.348 V16.3.0, the disclosure of which is incorporated by reference herein in its entirety, “Update Session Properties” can be used to update the session properties including the file list. However, there is no description in clause 5.5.2 of 3GPP TS 23.682 V17.2.0 on how the group message can be deliver by using the update session properties.

When cancel a group message delivery, if SCEF simply invokes Terminate Session towards Broadcast Multicast Service Centre (BM-SC), the MBMS session can be terminated successfully, but UEs are not aware of the cancellation of the group message.

In 3GPP TR 23.700-47 V0.2.0, the disclosure of which is incorporated by reference herein in its entirety, the modify group message over MBS clause requires further study.

To overcome or mitigate at least one above mentioned problems or other problems, the embodiments of the present disclosure propose an improved solution for group message modification and cancel.

In a first aspect of the disclosure, there is provided a method performed by an exposure node. The method comprises receiving a group message request from an application node.

In an embodiment, when the group message request is for a modification of group message delivery and comprises group message payload, the method may further comprise transforming the group message payload into a file.

In an embodiment, the method may further comprise, sending the file to a second broadcast multicast node.

In an embodiment, when the group message request is for a cancellation of group message delivery, the method may further comprise sending a first indication of a cancel of a file delivery to the third broadcast multicast node.

In an embodiment, when the group message request is for a cancellation of group message delivery, the method may further comprise sending an HTTP DELETE to the second broadcast multicast node to cancel file delivery.

In an embodiment, determined file meta data may be used as meta data information of the file.

In an embodiment, the determined file meta data may comprise a file uniform resource locator (URL) and/or a file uniform resource identifier (URI).

In an embodiment, an ingest mode or object acquisition method may be set to pull.

In an embodiment, an ingest mode or object acquisition method may be set to push.

In an embodiment, when an ingest mode or object acquisition method is set to pull, sending the file to the second broadcast multicast node may comprise sending a second indication of an update of the file to a third broadcast multicast node which will send a third indication based on the second indication to the second broadcast multicast node, receiving a request for fetching the file from the second broadcast multicast node, and sending a response comprising the file to the second broadcast multicast node.

In an embodiment, the second indication may be a property or a parameter with a refresh or update value within session parameters to inform the second broadcast multicast node about the refresh of the file.

In an embodiment, when an ingest mode or object acquisition method is set to push, sending the file to the second broadcast multicast node may comprise pushing the file to the second broadcast multicast node.

In an embodiment, the file may be included in a file list.

In an embodiment, the first indication may be a property or a parameter with a cancel value to inform the second broadcast multicast node about cancel of file delivery.

In an embodiment, the exposure node may comprise at least one of a Network Exposure Function (NEF) or a combined NEF and Service Capability Exposure Function (SCEF).

In an embodiment, the second broadcast multicast node may comprise a Multicast/Broadcast Service Transport Function (MBSTF).

In an embodiment, the third broadcast multicast node may comprise a Multicast/Broadcast Service Function (MBSF).

In an embodiment, the group message request may comprise a modify group message request with a requested action set to modify or cancel.

In an embodiment, the group message request may comprise a modify group message request or a cancel group message request.

In a second aspect of the disclosure, there is provided a method performed by a second broadcast multicast node. The method may comprise receiving a file from an exposure node or receiving an HTTP DELETE for canceling file delivery from the exposure node or receiving a first indication of a cancel of file delivery from a third broadcast multicast node. The file may be transformed from a group message payload and the group message payload may be comprised in a group message request indicating a modification or cancellation of group message delivery from an application node to the exposure node.

In an embodiment, the method may further comprise, when receiving the file and a group message delivery hasn't started, encoding the file and using the file to replace an original file. The file will be delivered after the group message delivery starts.

In an embodiment, the method may further comprise, when receiving the file and the group message delivery has started, encoding the file, stopping on-going group message delivery and starting a delivery of the file or starting the delivery of the file after the on-going group message is delivered.

In an embodiment, the method may further comprise, when receiving the first indication or the HTTP DELETE and the group message delivery has started, stopping file delivery and/or informing a multicast/broadcast service, MBS, client a cancellation of file delivery.

In an embodiment, the method may further comprise, when receiving the first indication or the HTTP DELETE and a group message delivery hasn't started, canceling file delivery and/or informing a multicast/broadcast service (MBS) client a cancellation of file delivery.

In an embodiment, the cancellation may be delivered in-band of an MBS session or out-band of the MBS session to at least one MBS client.

In an embodiment, determined file meta data may be used as meta data information of the file.

In an embodiment, the determined file meta data may comprise a file uniform resource locator (URL) and/or a file uniform resource identifier (URI).

In an embodiment, when an ingest mode or object acquisition method is set to pull, receiving the file from the exposure node may comprise receiving a third indication based on a second indication of an update of the file from the third broadcast multicast node, sending a request for fetching the file to the exposure node, and receiving the file from the exposure node.

In an embodiment, the second indication may be a property or a parameter with a refresh or update value to inform the second broadcast multicast node about the refresh of the file.

In an embodiment, when an ingest mode or object acquisition method is set to push, receiving the file from the exposure node may comprise receiving the file pushed by the exposure node.

In an embodiment, the file may be included in a file list.

In an embodiment, the first indication may be a property or a parameter with a cancel value to inform the second broadcast multicast node about cancel of file delivery.

In an embodiment, the exposure node may comprise a NEF or a combined NEF and SCEF.

In an embodiment, the second broadcast multicast node may comprise an MBSTF.

In an embodiment, the third broadcast multicast node may comprise an MBSF.

In an embodiment, the group message request may comprise a modify group message request with a requested action set to modify or cancel.

In an embodiment, the group message request may comprise a modify group message request or a cancel group message request.

In a third aspect of the disclosure, there is provided a method performed by a third broadcast multicast node. The method may comprise receiving a second indication of an update of a file or a first indication of a cancel of file delivery from an exposure node. The file may be transformed from the group message payload and the group message payload may be comprised in a group message request indicating a modification or cancellation of group message delivery from an application node to the exposure node. The method may further comprise sending the second indication or the first indication to a second broadcast multicast node.

In an embodiment, the method may further comprise, when receiving the first indication, informing a multicast/broadcast service (MBS) client a cancellation of file delivery.

In an embodiment, the cancellation may be delivered in-band of an MBS session or out-band of the MBS session to at least one MBS client.

In an embodiment, the first indication may be a property or a parameter with a cancel value to inform the second broadcast multicast node about cancel of file delivery.

In an embodiment, the second indication may be a property or a parameter with a refresh or update value within session parameters to inform the second broadcast multicast node about the refresh of the file.

In an embodiment, the exposure node may comprise a NEF or a combined NEF and SCEF.

In an embodiment, the second broadcast multicast node may comprise an MBSTF.

In an embodiment, the third broadcast multicast node may comprise an MBSF.

In an embodiment, the group message request may comprise a modify group message request with a requested action set to modify or cancel.

In an embodiment, the group message request may comprise a modify group message request or a cancel group message request.

In a fourth aspect of the disclosure, there is provided a method performed by a user equipment. The method may comprise receiving a message from a second broadcast multicast node or a third broadcast multicast node. The message comprises a cancellation of file delivery.

In an embodiment, the cancellation may be received in-band of a multicast/broadcast service, MBS, session or out-band of the MBS session

In an embodiment, the user equipment may comprise an MBS client.

In an embodiment, the second broadcast multicast node may comprise an MBSTF.

In an embodiment, the third broadcast multicast node may comprise an MBSF.

In another aspect of the disclosure, there is provided an exposure node. The exposure node comprises a processor and a memory coupled to the processor. Said memory contains instructions executable by said processor. Said exposure node is operative to receive a group message request from an application node.

In an embodiment, when the group message request is for a modification of group message delivery and comprises group message payload, said exposure node is further operative to transform the group message payload into a file. Said exposure node is further operative to send the file to a second broadcast multicast node.

In an embodiment, when the group message request is for a cancellation of group message delivery, said exposure node is further operative to send a first indication of a cancel of a file delivery to the third broadcast multicast node.

In an embodiment, when the group message request is for a cancellation of group message delivery, said exposure node is further operative to send an HTTP DELETE to the second broadcast multicast node to cancel file delivery.

In another aspect of the disclosure, there is provided a second broadcast multicast node. Second broadcast multicast node comprises a processor and a memory coupled to the processor. Said memory contains instructions executable by said processor. Said second broadcast multicast node is operative to receive a file from an exposure node or receiving an HTTP DELETE for canceling file delivery from the exposure node or receiving a first indication of a cancel of file delivery from a third broadcast multicast node. The file may be transformed from a group message payload and the group message payload may be comprised in a group message request indicating a modification or cancellation of group message delivery from an application node to the exposure node.

In another aspect of the disclosure, there is provided a third broadcast multicast node. The third broadcast multicast node comprises a processor and a memory coupled to the processor. Said memory contains instructions executable by said processor. Said third broadcast multicast node is operative to receive a second indication of an update of a file or a first indication of a cancel of file delivery from an exposure node. The file is transformed from the group message payload and the group message payload is comprised in a group message request indicating a modification or cancellation of group message delivery from an application node to the exposure node. Said third broadcast multicast node is further operative to send the second indication or the first indication to a second broadcast multicast node.

In another aspect of the disclosure, there is provided a user equipment. The user equipment comprises a processor and a memory coupled to the processor. Said memory contains instructions executable by said processor. Said user equipment is operative to receive a message from a second broadcast multicast node or a third broadcast multicast node. The message may comprise a cancellation of file delivery.

In another aspect of the disclosure, there is provided an exposure node. The exposure node comprises a first receiving module configured to receive a group message request from an application node.

In an embodiment, when the group message request is for a modification of group message delivery and comprises group message payload, the exposure node further comprises a transforming module configured to transform the group message payload into a file. The exposure node further comprises a first sending module configured to send the file to a second broadcast multicast node.

In an embodiment, when the group message request is for a cancellation of group message delivery, the exposure node may further comprise a third sending module configured to send a first indication of a cancel of a file delivery to the third broadcast multicast node. The exposure node may further comprise a fourth sending module configured to send an HTTP DELETE to the second broadcast multicast node to cancel file delivery.

In another aspect of the disclosure, there is provided a second broadcast multicast node. The second broadcast multicast node comprises a first receiving module configured to receive a file from an exposure node or receive an HTTP DELETE for canceling file delivery from the exposure node or receive a first indication of a cancel of file delivery from a third broadcast multicast node. The file may be transformed from a group message payload and the group message payload may be comprised in a group message request indicating a modification or cancellation of group message delivery from an application node to the exposure node.

In an embodiment, when receiving the file and a group message delivery hasn't started, the second broadcast multicast node may further comprise a first encoding module configured to encode the file and a first using module configured to use the file to replace an original file. The file will be delivered after the group message delivery starts.

In an embodiment, when receiving the file and the group message delivery has started, the second broadcast multicast node further comprises a second encoding module configured to encode the file, a first stopping module configured to stop on-going group message delivery and a first starting module configured to start a delivery of the file or start the delivery of the file after the on-going group message is delivered.

In an embodiment, when receiving the first indication or the HTTP DELETE and the group message delivery has started, the second broadcast multicast node further comprises a third stopping module configured to stop file delivery and/or a first informing module configured to inform a multicast/broadcast service (MBS) client a cancellation of file delivery.

In an embodiment, when receiving the first indication or the HTTP DELETE and a group message delivery hasn't started, the second broadcast multicast node further comprises a canceling module configured to cancel file delivery and/or a second informing module configured to inform a multicast/broadcast service (MBS) client a cancellation of file delivery.

In another aspect of the disclosure, there is provided a third broadcast multicast node. The third broadcast multicast node comprises a receiving module configured to receive a second indication of an update of a file or a first indication of a cancel of file delivery from an exposure node. The file is transformed from the group message payload and the group message payload is comprised in a group message request indicating a modification or cancellation of group message delivery from an application node to the exposure node. The third broadcast multicast node further comprises a sending module configured to send the second indication or the first indication to a second broadcast multicast node.

In another aspect of the disclosure, there is provided a user equipment. The user equipment comprises a receiving module configured to receive a message from a second broadcast multicast node or a third broadcast multicast node. The message comprises a cancellation of file delivery.

In another aspect of the disclosure, there is provided a computer-readable storage medium storing instructions which when executed by at least one processor, cause the at least one processor to perform any of the methods according to the first, second, third and fourth aspects of the disclosure.

In another aspect of the disclosure, there is provided a computer program product, comprising instructions which, when executed on at least one processor, cause the at least one processor to carry out any of the methods according to the first, second, third and fourth aspects of the disclosure.

In another aspect of the disclosure, there is provided a communication system including a host computer. The host computer includes processing circuitry configured to provide user data and a communication interface configured to forward the user data to a cellular network for transmission to a terminal device. The cellular network includes the network device (such as radio access network node, the exposure node, the second broadcast multicast node, or the third broadcast multicast node), and/or the terminal device (such as terminal device above mentioned).

In embodiments of the present disclosure, the system further includes the terminal device. The terminal device is configured to communicate with the network device.

In embodiments of the present disclosure, the processing circuitry of the host computer is configured to execute a host application, thereby providing the user data; and the terminal device includes processing circuitry configured to execute a client application associated with the host application.

In another aspect of the disclosure, there is provided a communication system including a host computer and a network device. The host computer includes a communication interface configured to receive user data originating from a transmission from a terminal device. The transmission is from the terminal device to the network device. The network device is radio access network node, the exposure node, the second broadcast multicast node, or the third broadcast multicast node, and/or the terminal device is above mentioned terminal device.

In embodiments of the present disclosure, the processing circuitry of the host computer is configured to execute a host application. The terminal device is configured to execute a client application associated with the host application, thereby providing the user data to be received by the host computer.

In another aspect of the disclosure, there is provided a method implemented in a communication system which may include a host computer, a network device and a terminal device. The method may comprise providing user data at the host computer. Optionally, the method may comprise, at the host computer, initiating a transmission carrying the user data to the terminal device via a cellular network comprising the network device.

In another aspect of the disclosure, there is provided a communication system including a host computer. The host computer may comprise processing circuitry configured to provide user data, and a communication interface configured to forward the user data to a cellular network for transmission to a terminal device. The cellular network may comprise a network device having a radio interface and processing circuitry.

In another aspect of the disclosure, there is provided a method implemented in a communication system which may include a host computer, a network device and a terminal device. The method may comprise providing user data at the host computer. Optionally, the method may comprise, at the host computer, initiating a transmission carrying the user data to the terminal device via a cellular network comprising the network device. The terminal device may perform any step of the methods according to the fourth aspect of the present disclosure.

In another aspect of the disclosure, there is provided a communication system including a host computer. The host computer may comprise processing circuitry configured to provide user data, and a communication interface configured to forward user data to a cellular network for transmission to a terminal device. The terminal device may comprise a radio interface and processing circuitry. The terminal device's processing circuitry may be configured to perform any step of the methods according to the fourth aspect of the present disclosure.

In another aspect of the disclosure, there is provided a method implemented in a communication system which may include a host computer, a network device and a terminal device. The method may comprise, at the host computer, receiving user data transmitted to the network device from the terminal device which may perform any step of the methods according to the fourth aspect of the present disclosure.

In another aspect of the disclosure, there is provided a communication system including a host computer. The host computer may comprise a communication interface configured to receive user data originating from a transmission from a terminal device to a network device. The terminal device may comprise a radio interface and processing circuitry. The terminal device's processing circuitry may be configured to perform any step of the methods according to the fourth aspect of the present disclosure.

In another aspect of the disclosure, there is provided a method implemented in a communication system which may include a host computer, a network device and a terminal device. The method may comprise, at the host computer, receiving, from the network device, user data originating from a transmission which the network device has received from the terminal device.

In another aspect of the disclosure, there is provided a communication system which may include a host computer. The host computer may comprise a communication interface configured to receive user data originating from a transmission from a terminal device to a network device. The network device may comprise a radio interface and processing circuitry.

Many advantages may be achieved by applying the proposed solution according to embodiments of the present disclosure. For example, some embodiments herein may enable the group message modification and group message cancellation over MBMS, MBS and MBS with interworking with MBMS. Some embodiments herein may fix the drawbacks within the current group message modification via MBMS (it is not workable to replace the group message using Update Session Properties to BM-SC). Some embodiments herein may improve the limitation with the current group message cancellation via MBMS (SCEF Terminate Session towards BM-SC but UE is not aware of the cancellation of the group message). The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A shows an example of delivery methods;

FIG. 1B shows a 5G system architecture for Multicast and Broadcast Service;

FIG. 1C shows a 5G System architecture for Multicast and Broadcast Service in reference point representation;

FIG. 1D shows MBS-eMBMS interworking system architecture at service layer FIG. 1E shows a flowchart of MBS session creation with PCC;

FIG. 1E shows a flowchart of MBS session update without PCC;

FIG. 1F shows a flowchart of MBS session update with PCC;

FIG. 1G shows a flowchart of MBS Session Update for Broadcast;

FIG. 1H shows a flowchart of MBS Session Deletion without PCC;

FIG. 1I shows a flowchart of MBS Session Deletion with PCC;

FIG. 1J shows a flowchart of MBS Session Release for Broadcast;

FIG. 1K shows a flowchart of Group Message Delivery via MBS Broadcast;

FIG. 1L shows a flowchart of Modification of previously submitted Group Message;

FIG. 2A shows a flowchart of a method according to an embodiment of the present disclosure;

FIG. 2B shows a flowchart of a method according to another embodiment of the present disclosure;

FIG. 2C shows a flowchart of a method according to another embodiment of the present disclosure;

FIG. 2D shows a flowchart of a method according to another embodiment of the present disclosure;

FIG. 2E shows a flowchart of a method according to another embodiment of the present disclosure;

FIG. 2F shows a flowchart of a method according to another embodiment of the present disclosure;

FIG. 2G shows a flowchart of a method according to another embodiment of the present disclosure;

FIG. 3A shows a flowchart of a method according to another embodiment of the present disclosure;

FIG. 3B shows a flowchart of a method according to another embodiment of the present disclosure;

FIG. 3C shows a flowchart of a method according to another embodiment of the present disclosure;

FIG. 3D shows a flowchart of a method according to another embodiment of the present disclosure;

FIG. 3E shows a flowchart of a method according to another embodiment of the present disclosure;

FIG. 3F shows a flowchart of a method according to another embodiment of the present disclosure;

FIG. 3G shows a flowchart of a method according to another embodiment of the present disclosure;

FIG. 3H shows a flowchart of a method according to another embodiment of the present disclosure;

FIG. 3I shows a flowchart of a method according to another embodiment of the present disclosure;

FIG. 4A shows a flowchart of a method according to another embodiment of the present disclosure;

FIG. 4B shows a flowchart of a method according to another embodiment of the present disclosure;

FIG. 4C shows a flowchart of a method according to another embodiment of the present disclosure;

FIG. 4D shows a flowchart of a method according to another embodiment of the present disclosure;

FIG. 4E shows a flowchart of a method according to another embodiment of the present disclosure;

FIG. 4F shows a flowchart of a method according to another embodiment of the present disclosure;

FIG. 4G shows a flowchart of a method according to another embodiment of the present disclosure;

FIG. 4H shows a flowchart of a method according to another embodiment of the present disclosure;

FIG. 4I shows a flowchart of a method according to another embodiment of the present disclosure;

FIG. 5 shows a flowchart of a method according to another embodiment of the present disclosure;

FIG. 6A shows a flowchart of a method according to another embodiment of the present disclosure;

FIG. 6B shows a flowchart of Group Message Delivery over MBMS in EPS according to another embodiment of the present disclosure;

FIG. 6C shows a flowchart of another option of step 3 to step 5 of FIG. 6B according to another embodiment of the present disclosure;

FIG. 6D shows a flowchart of Group Message Modification and Cancellation over MBS broadcast according to another embodiment of the present disclosure;

FIG. 6E shows a flowchart of another option of step 3 to step 6 of FIG. 6D according to another embodiment of the present disclosure;

FIG. 6F shows a flowchart of Group Message Delivery over MBMS and MBS broadcast according to another embodiment of the present disclosure;

FIG. 6G shows a flowchart of another option of step 3 to step 5 of FIG. 6F according to another embodiment of the present disclosure;

FIG. 7 shows a flowchart of Modify or Cancel Group Message Delivery via MBS Broadcast according to another embodiment of the present disclosure;

FIG. 8A is a block diagram showing an apparatus suitable for practicing some embodiments of the disclosure;

FIG. 8B is a block diagram showing an exposure node according to an embodiment of the disclosure;

FIG. 8C is a block diagram showing a first broadcast multicast node according to an embodiment of the disclosure;

FIG. 8D is a block diagram showing a second broadcast multicast node according to an embodiment of the disclosure;

FIG. 8E is a block diagram showing a third broadcast multicast node according to an embodiment of the disclosure;

FIG. 9 is a block diagram showing a user equipment according to an embodiment of the disclosure;

FIG. 10 is a schematic showing a wireless network in accordance with some embodiments;

FIG. 11 is a schematic showing a user equipment in accordance with some embodiments;

FIG. 12 is a schematic showing a virtualization environment in accordance with some embodiments;

FIG. 13 is a schematic showing a telecommunication network connected via an intermediate network to a host computer in accordance with some embodiments;

FIG. 14 is a schematic showing a host computer communicating via a base station with a user equipment over a partially wireless connection in accordance with some embodiments;

FIG. 15 is a schematic showing methods implemented in a communication system including a host computer, a base station and a user equipment in accordance with some embodiments;

FIG. 16 is a schematic showing methods implemented in a communication system including a host computer, a base station and a user equipment in accordance with some embodiments;

FIG. 17 is a schematic showing methods implemented in a communication system including a host computer, a base station and a user equipment in accordance with some embodiments; and

FIG. 18 is a schematic showing methods implemented in a communication system including a host computer, a base station and a user equipment in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in onc or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function (NF)” refers to any suitable function which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

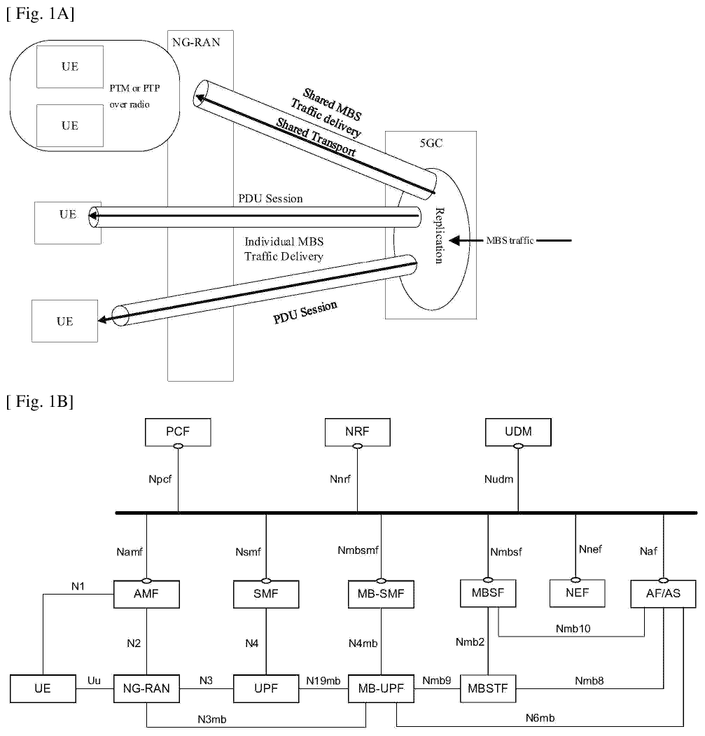

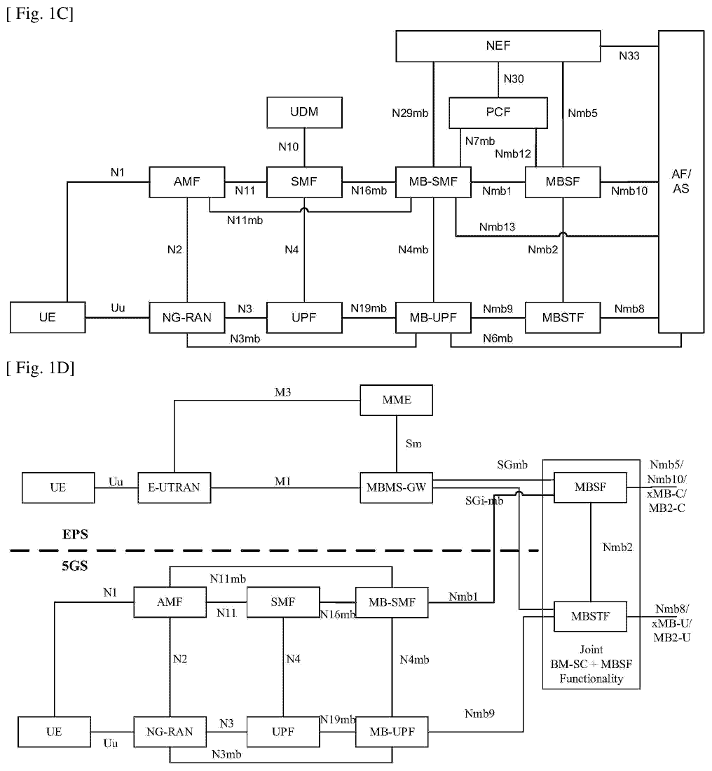

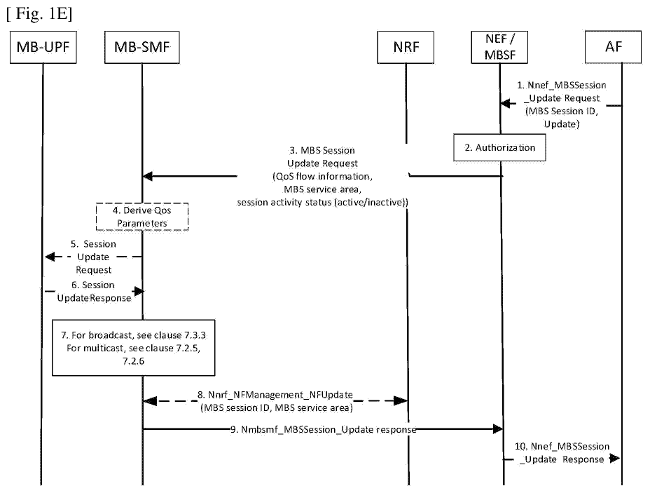

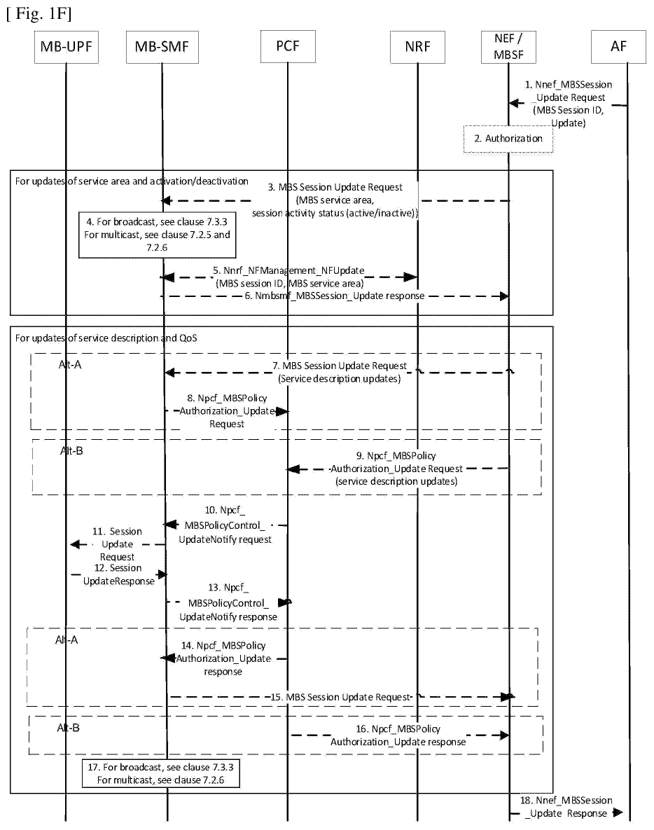

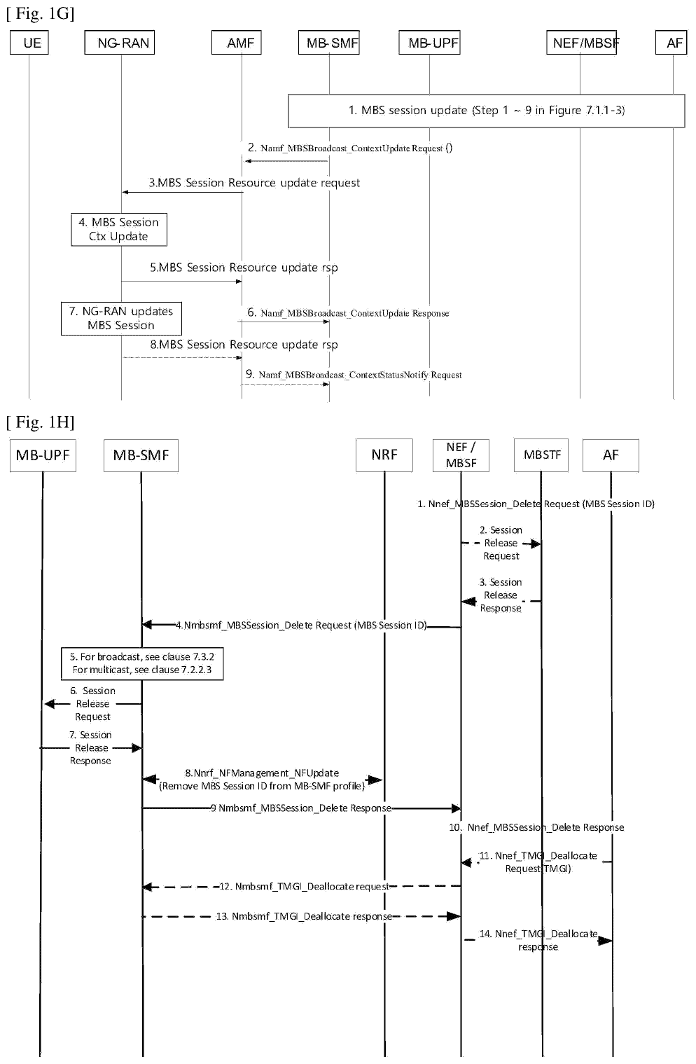

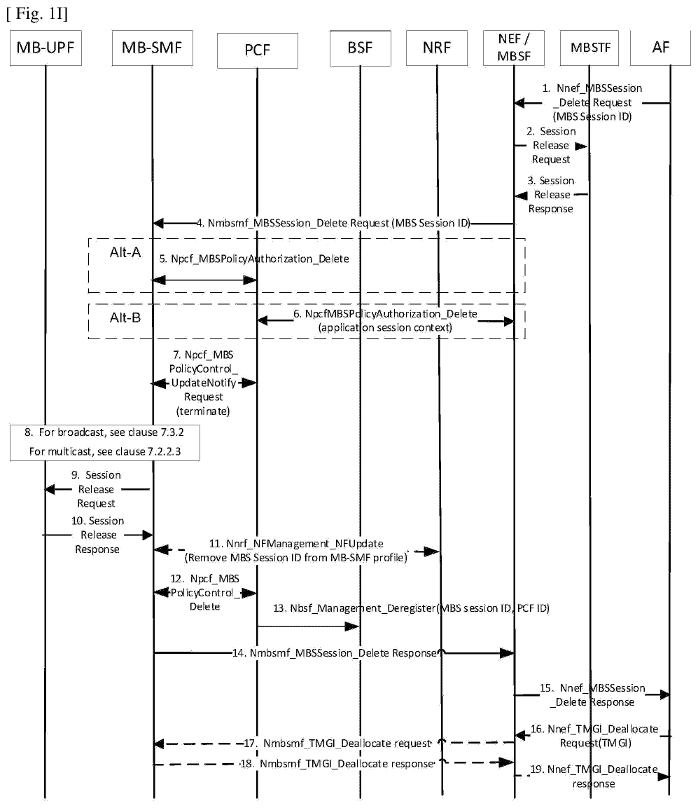

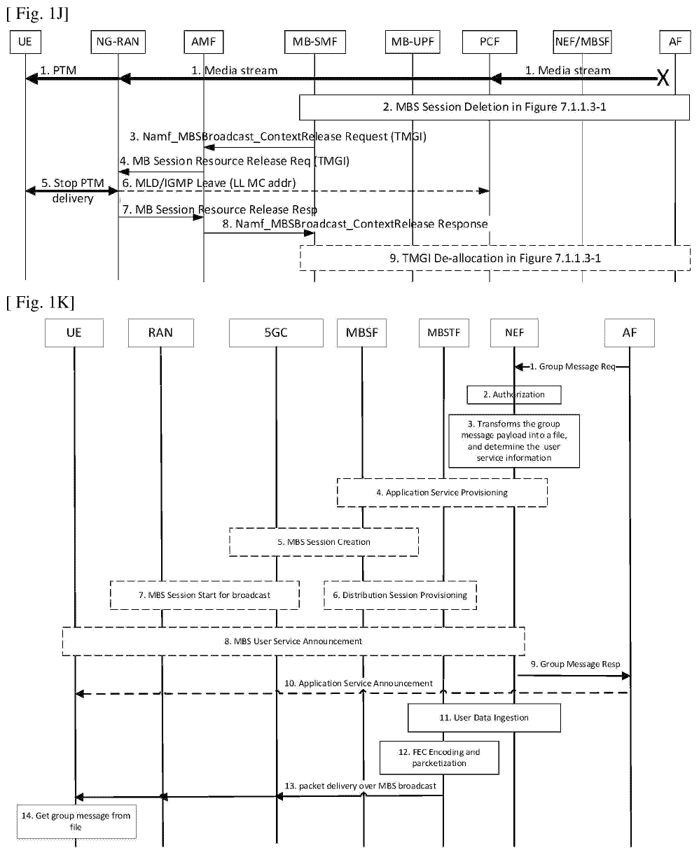

Although the subject matter described herein may be implemented in any appropriate type of system using any suitable components, the embodiments disclosed herein are described in relation to a communication system complied with the exemplary system architecture illustrated in FIG. 1B, FIG. 1C and FIG. 1D. For simplicity, the system architecture of FIG. 1B, FIG. 1C and FIG. 1D only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

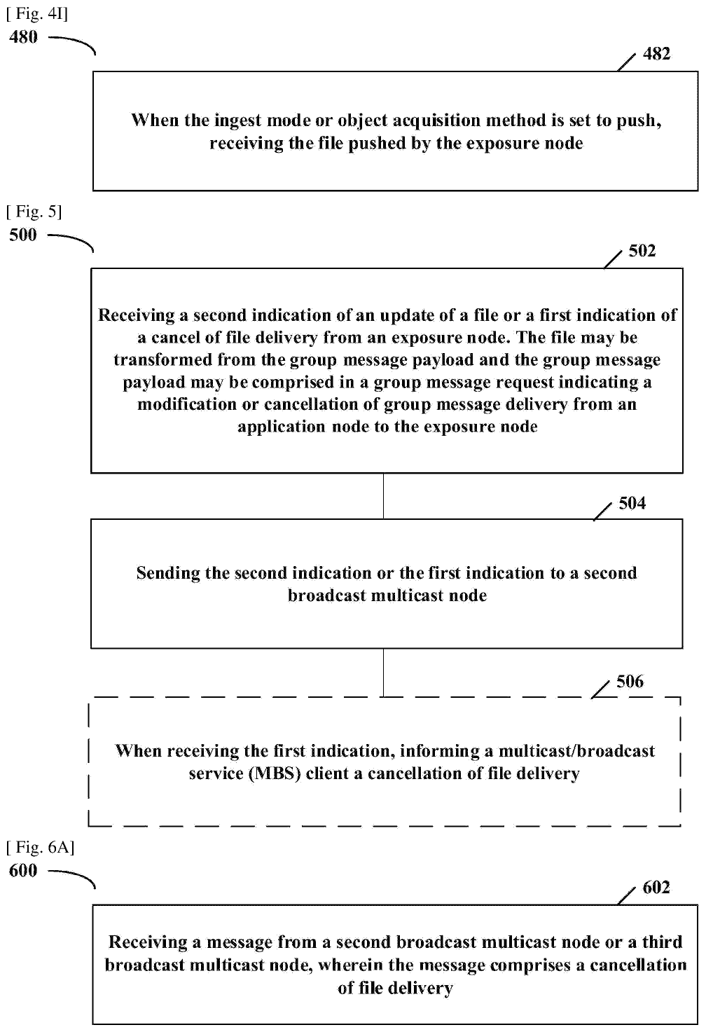

FIG. 1B shows a 5G system architecture for Multicast and Broadcast Service, which is same as FIGS. 5.1-1 of 3GPP TS 23.247 V17.2.0. FIG. 1C shows a 5G System architecture for Multicast and Broadcast Service in reference point representation, which is same as FIGS. 5.1-2 of 3GPP TS 23.247 V17.2.0. The 5G MBS system architecture may comprise functional entities such as PCF (Policy Control Function), MB-SMF (Multicast/Broadcast Session Management Function), SMF (Session Management Function), MB-UPF (Multicast/Broadcast User plane Function), UPF (User plane Function), AMF (Access and mobility Function), NG-RAN (next generation radio access network), UE (user equipment), AF/AS (Application Function/Application Server), NEF (Network Exposure Function), MBSF (Multicast/Broadcast Service Function), MBSTF (Multicast/Broadcast Service Transport Function), UDM (Unified Data Management), UDR (Unified Data Repository), NRF (Network Repository Function), etc. These functional entities have been described in clause 5.3.2 of 3GPP TS 23.247 V17.2.0.

The MBSF is optional and may be collocated with the NEF or AF/AS, and the MBSTF is an optional network function.

The existing service-based interfaces of Nnrf, Nudm, and Nsmf are enhanced to support MBS. The existing service-based interfaces of Npcf and Nnef are enhanced to support MBS.

A MBS-enabled AF uses either Nmbsf or Nnef to interact with the MBSF.

SMF and MB-SMF may be co-located or deployed separately.

The MBS System Architecture may contain the following reference points:

N3mb: Reference point between the (R) AN and the MB-UPF.

N4mb: Reference point between the MB-SMF and the MB-UPF.

N6mb: Reference point between the MB-UPF and the AF/AS.

N7mb: Reference point between the MB-SMF and the PCF.

N11mb: Reference point between the AMF and the MB-SMF.

N16mb: Reference point between the SMF and the MB-SMF.

N19mb: Reference Point between the UPF and the MB-UPF.

N29mb: Reference point between the MB-SMF and the NEF.

Nmb1: Reference point between the MB-SMF and the MBSF.

Nmb2: Reference point between the MBSF and the MBSTF.

Nmb5: Reference point between the MBSF and the NEF.

Nmb8: Reference point between the MBSTF and the AF.

Nmb9: Reference point between the MB-UPF and the MBSTF.

Nmb10: Reference point between the MBSF and the AF.

Nmb12: Reference point between the MBSF and the PCF.

Nmb13: Reference point between the MB-SMF and the AF.

The existing reference points of N1, N2, N4, N10, N11, N30 and N33 are enhanced to support MBS.

Regarding the functionalities, Nmb13, N29mb and Nmb1 are identical, Nmb5 and Nmb10 are identical, Nmb9 and N6mb are identical.

FIG. 1D shows MBS-eMBMS interworking system architecture at service layer, which is same as FIGS. 5.2-1 of 3GPP TS 23.247 V17.2.0.

Interworking between MBS and eMBMS (Evolved MBMS) at service layer functionality applies in cases where the same Multicast/Broadcast service is provided via eMBMS and MBS. FIG. 1D depicts the system architecture for interworking between E-UTRAN/EPC eMBMS and MBS at service layer, with collocated BM-SC and MBSF/MBSTF functionalities. E-UTRAN denotes Evolved Universal Terrestrial Radio Access Network. EPC denotes Evolved Packet Core.

The BM-SC+MBSF/MBSTF exposes common Nmb5/Nmb10/xMB-C/MB2-C and Nmb8/xMB-U/MB2-U reference points to the NEF and/or AF/AS. A common TMGI is used towards the AF/AS. The TMGI is also used as identifier for transport over E-UTRANEPC.

NOTE: MB2-C/U are both legacy reference points and 5GS reference points.

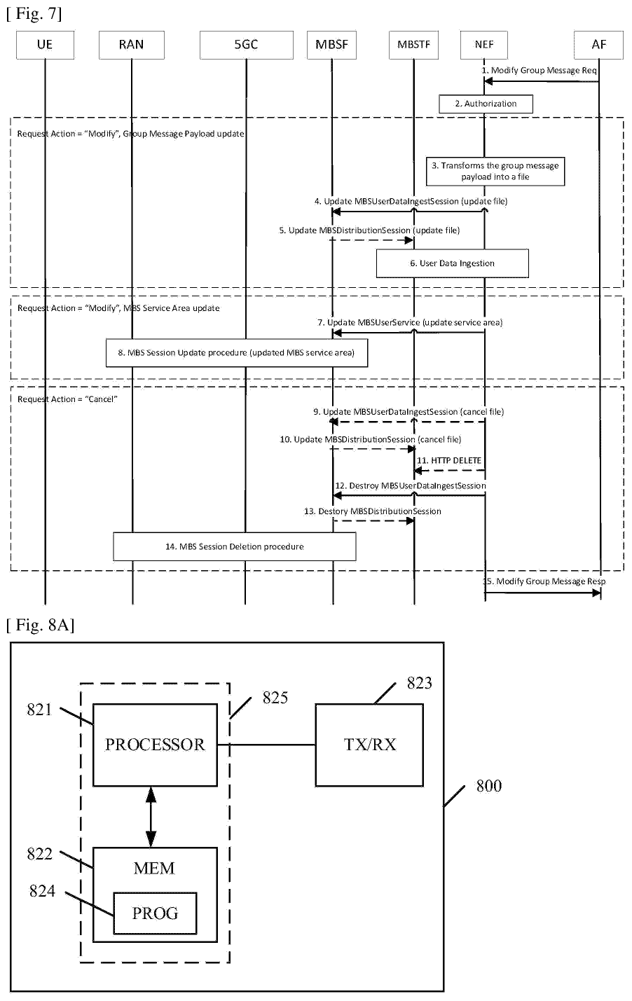

FIG. 1E shows a flowchart of MBS session update without Policy and Charging Control (PCC), which is same as FIG. 7.1.1.6-1 of 3GPP TS 23.247 V17.2.0.

The following italics content is a copy of clause 7.1.1.6 of 3GPP TS 23.247 V17.2.0.

This procedure is used by the AF to update the MBS service area and/or update QoS of an MBS Session. Updating QoS of an MBS Session may lead to addition of new MBS QoS Flow(s). The procedure applies to both multicast and broadcast communications unless otherwise stated.

For local multicast services and location dependent multicast services, the AF may perform a Service Announcement towards UEs to update the MBS service area before the MBS Session Update procedure is started or after the MBS Session Update procedure is completed.

1. AF of content provider initiates MBS Session Update to a NEF/MBSF, e.g. to update MBS service area and/or update service requirement, or to activate or deactivate an MBS session. AF may provide updated information for an MBS session (identified by MBS session ID) by sending MBS Session update request ([MBS Session ID], MBS information, AF Identifier). MBS information may include service requirements, MBS service area information, and media information. The service requirements adjustment may lead to addition of new MBS QoS Flow(s), removal of existing MBS QoS Flow(s) or update of existing MBS QoS Flow(s).

2. NEF checks authorization of AF.

3. NEF/MBSF forward the MBS Session Update request to MB-SMF.

4. The MB-SMF derives any updated QoS parameters locally.

5-6. MB-SMF may need to update MB-UPF, e.g. if new MBS QoS Flow is to be

created, or existing MBS QOS Flow is to be deleted.

7. For broadcast communication, the MB-SMF continues the procedure towards the AMF and NG-RAN as specified in clause 7.3.3. For multicast communication, the MB-SMF continues the procedure towards the AMF and NG-RAN as specified in clause 7.2.5 (for service activation/deactivation), 7.2.6 (for QoS updates and service area updates).

8. If an MBS service area is being updated, the MB-SMF stores the new service area in its profile at the NRF.

9. MB-SMF responds to the MBS Session Update.

10. NEF/MBSF responds to the MBS Session Update.

FIG. 1F shows a flowchart of MBS session update with PCC, which is same as FIG. 7.1.1.7-1 of 3GPP TS 23.247 V17.2.0.

The following italics content is a copy of clause 7.1.1.7 of 3GPP TS 23.247 V17.2.0.

For local multicast services and location dependent multicast services, the AF may perform a Service Announcement towards UEs to update the MBS service area before the MBS Session Update procedure is started or after the MBS Session Update procedure is completed.

### 1-2. Same as in FIG. 7.1.1.6-1.

For updates of MBS service area and/or MBS session activation/deactivation steps 3 to 6 apply

3. NEF/MBSF forward the MBS Session Update request to MB-SMF, removing any updates not related to MBS service area and/or MBS session activation/deactivation

4. For broadcast communication, the MB-SMF continues the procedure towards the AMF and NG-RAN as specified in clause 7.3.3. For multicast communication, the MB-SMF continues the procedure towards the AMF and NG-RAN as specified in clause 7.2.5 (for service activation/deactivation), and 7.2. x (for service area updates).

5. If an MBS service area is being updated, the MB-SMF stores the new service area in its profile at the NRF.

6. MB-SMF responds to the MBS Session Update.

For other updates of the service description and QoS related updates, there are two alternatives.

In the Alt-A, the MB-SMF is the Npcf_MBSPolicy Authorization_Update service operation consumer. Steps 7, 8, 14 and 15 apply.

In the Alt-B, the NEF is the Npcf_MBSPolicy Authorization_Update service operation consumer. Steps 12 and 16 apply.

Steps 10 to 13 and 27 are executed for both Alt-A and Alt-B.

7. [Optional, Alt-A] NEF/MBSF forward the MBS Session Update request to MB-SMF.

8. [Optional, Alt-A] The MB-SMF sends an Npcf_MBSPolicy Authorization_Update Request to PCF with updated service requirements. The PCF determines whether the request is authorized.

9. [Optional, Alt-B] NEF/MBSF updates the MBS policy Authorization for the MBS session at the PCF and provides the input received from the AF, removing any updates related to MBS service area and/or MBS session activation/deactivation, by sending Npcf_MBSPolicy Authorization_Update Request message (MBS Session ID, service requirement).

10. Based on the input received in step 9 or 10, the PCF may provide updated policy rules to the MB-SMF by issuing Npcf_MBSPolicyControl_UpdateNotify request message including the updated policy information about the MBS Session.

11-12. Same as steps 5-6 in FIG. 7.1.1.6-1.

13. The MB-SMF sends Npcf_MBSPolicyControl_UpdateNotify reply to PCF.

14. [Optional, Alt-A] The PCF sends the Npcf_MBSPolicy Authorization_Update response to the MB-SMF.

15. [Optional, Alt-A] MB-SMF responds to the MBS Session Update.

16. [Optional, Alt-B] The PCF sends the Npcf_MBSPolicy Authorization_Update response to the NEF/MBSF.

17. For broadcast communication, the MB-SMF continues the procedure towards the AMF and NG-RAN as specified in clause 7.3.3. For multicast communication, the MB-SMF continues the procedure towards the AMF and NG-RAN as specified in clause 7.2.6 (for QoS updates).

18. Same as step 10 in FIG. 7.1.1.6-1.

FIG. 1G shows a flowchart of MBS Session Update for Broadcast, which is same as FIG. 7.3.3-1 of 3GPP TS 23.247 V17.2.0.

The following italics content is a copy of clause 7.3.3 of 3GPP TS 23.247 V17.2.0.

The MBS Session Update for broadcast is used by the AF to update the broadcast area or service requirements of the MBS Session which may lead to addition of new MBS QoS Flow(s), removal of existing MBS QoS Flow(s) or update of existing MBS QOS Flow(s).

1. The AF starts MBS session update procedure by sending

Nnef_MBSSession_Update Request to the NEF/MBSF with TMGI. The AF may adjust service requirement and/or broadcast area. The service requirements adjustment may lead to addition of new MBS QoS Flow(s), removal of existing MBS QoS Flow(s) or update of existing MBS QoS Flow(s).

2. The MB-SMF sends Namf_MBSBroadcast_ContextUpdate Request (TMGI, N2 SM information ([5G QoS Profile]), [updated MBS service area]) to the AMFs. If the broadcast area is updated, the MB-SMF may use NRF to discover the AMF(s) based on the new broadcast area and select the appropriate one(s). The MB-SMF may include a maximum response time in the request.

Depending on the change of the MBS service area, the MB-SMF may send Namf_MBSBroadcast_ContextCreate to some AMFs in the new MBS service area, Namf_MBSBroadcast_ContextRelease to some other AMFs in the old MBS service area.

3. The AMF sends MBS Session Resource Update to NG-RANs with TMGI, the updated 5G QoS Profile and the updated MBS service area.

Depending on the change of the MBS service area, the AMF may send MBS Session Resource Setup to some NG-RANs in new MBS service area (see clause 7.3.1) and MBS Session Resource Release to some other NG-RANs in old MBS service area.

4. The NG-RAN updates MBS Session Context.

5. The NG-RAN reports successful update of the MBS Session resources (which may include multiple MBS QOS Flows) by sending MBS Session Resource Update Response (TMGI, N2 SM information ([N3mb DL Tunnel Info])) message(s) to the AMF. N3mb DL Tunnel Info is only available when point-to-point transport applies between MB-UPF and NG-RAN and the NG-RAN wants the transport to be changed. The NG-RAN should be ready to receive using the N3mb DL tunnel. For more details, refer to TS 38.413.

6. The AMF sends Namf_MBSBraodcast_ContextUpdate Response to the MB-SMF. If the AMF received the NG-RAN responses from all involved NG-RAN(s), the AMF should include an indication of completion of the operation in all NG-RANs.

7. The NG-RAN updates the MBS Session. It takes place in parallel with step 5 to step 6.

8 Another NG-RAN may report successful update of the MBS Session resources (which may include multiple MBS QoS Flows) by sending MBS Session Resource Update Response (TMGI, N2 SM information ([N3mb DL Tunnel Info])) message after the AMF transferred the Namf_MBSBroadest_ContextUpdate Response ( ) to the MB-SMF. N3mb DL Tunnel Info is only available when point-to-point transport applies between MB-UPF and NG-RAN and the NG-RAN wants the transport to be changed. The NG-RAN should be ready to receive using the N3mb DL tunnel. For more details, refer to TS 38.413.

9. The AMF transfers the Namf_MBSBroadcast_ContextStatusNotify request ( ) to the MB-SMF. When the AMF receives the response from all NG-RAN nodes, the AMF should include an indication of completion of the operation in all NG-RANs. If the AMF does not receive responses from all NG-RAN nodes before the maximum response time elapses since the reception of the Namf_MBSBroadcast_ContextUpdate Request, then the AMF should transfer the Namf_MBSBroadcast_ContextStatusNotify request ( ) which indicates partial success or failure.

FIG. 1H shows a flowchart of MBS Session Deletion without PCC, which is same as FIG. 7.1.1.4-1 of 3GPP TS 23.247 V17.2.0.

The following italics content is a copy of clause 7.1.1.4 of 3GPP TS 23.247 V17.2.0.

This procedure is used by the AF to delete the MBS Session. This procedure may also include TMGI de-allocation. The procedures apply to both multicast and broadcast communications unless otherwise stated. This procedure releases the reserved resources in both 5GC and NG-RAN.

1. AF of content provider may request to delete the MBS session (MBS Session ID).

2/3. If an MBSTF was inserted into the user plane, the MBSF request the MBSTF to release user plane resources.

4. NEF/MBSF requests MB-SMF to delete resources for the MBS session.

5. For broadcast session, the MB-SMF triggers resource release towards the AMFs as specified in clause 7.3.2. For multicast session, the MB-SMF triggers resource release towards the SMFs as specified in clause 7.2.2.3.

6/7. MB-SMF requests the MB-UPF to release user plane resources.

8. [Conditional] If MB-SMF configured the profile with an MBS session ID when the MBS session was created, the MB-SMF updates its NF profile at NRF to release the MBS Session ID.

9. MB-SMF responds to the NEF/MBSF.

10. The NEF/MBSF responds to the AF.

11. [Optional] AF requests NEF/MBSF to de-allocate TMGI(s),

12. [Conditional on step 11] NEF/MBSF forwards request to de-allocate TMGI(s) to MB-SMF.

13. [Conditional on step 12] The MB-SMF responds to the NEF or MBSF by sending a de-allocate TMGI Response message.

14. [Conditional on step 13] NEF or MBSF forwards de-allocate TMGI Response message to AF.

FIG. 1I shows a flowchart of MBS Session Deletion with PCC, which is same as FIG. 7.1.1.5-1 of 3GPP TS 23.247 V17.2.0.

The following italics content is a copy of clause 7.1.1.5-1 of 3GPP TS 23.247 V17.2.0.

This procedure is used by the AF to release the MBS Session. This procedure may also include TMGI de-allocation. The procedures apply to both multicast and broadcast communications unless otherwise stated. This procedure releases the reserved resources in both 5GC and NG-RAN.

### 1-4. Same as in FIG. 7.1.1.4-1.

There are two alternatives to initiate the policy Authorization service operation.

If the MB-SMF is the Npcf_MBSPolicy Authorization service consumer, i.e. Alt-Ain the clause 7.1.1.3, the step 5 is performed.

If the NEF is the Npcf_MBSPolicy Authorization service consumer, i.e. Alt-B in the clause 7.1.1.3, the step 6 is performed.

5. (Alt-A The MB-SMF sends an NMBSPolicy Authorization_Delete Request to the PCF that handles the Policy of the MBS Session.

6. (Alt-B) The NEF/MBSF sends an NMBSPolicy Authorization_Delete Request to the PCF that handles the Policy of the MBS Session.

7. The PCF sends an Npcf_MBSPolicyControl_UpdateNotify Request to MB-SMF to release the MBS Policy Control Association. The MB-SMF acknowledges the request. 8-11. Same as steps 5-8 in FIG. 7.1.1.4-1.

12. The MB-SMF sends the Npcf_MBSPolicyControl_Delete Request to request the deletion of the SM Policy Association with the PCF.

13. The PCF de-registers at the BSF that it handles the MBS session.

14. The MB-SMF sends the Nmbsmf_MBSSession_Delete Response to NEF/MBSF. 15-19. Same as steps 10-14 in FIG. 7.1.1.4-1.

FIG. 1J shows a flowchart of MBS Session Release for Broadcast, which is same as FIG. 7.3.2-1 of 3GPP TS 23.247 V17.2.0.

The following italics content is a copy of clause 7.3.2 of 3GPP TS 23.247 V17.2.0.

The MBS Session Release for broadcast follows the MBS Session Deletion (e.g. TMGI De-allocation and MBS Session Deletion) so that resource for shared MBS delivery is released. It is possible for AF to stop MBS Session but keep TMGI allocated.

1. The AF/AS may stop the media stream before sending the MBS Session Release Request (TMGI) message to the 3GPP network.

2. The AF/AS performs MBS Session Deletion procedure to request release of MBS Session (steps 1˜10 in FIG. 7.1.1.4-1, or steps 1˜13 in FIG. 7.1.1.5-1).

3. MB-SMF sends Namf_MBSBroadcast_ContextRelease request (TMGI) to the AMF(s) that has been involved in the MBS Session.

4. The AMF sends an N2 message to all RAN nodes that have been involved to release MBS session. If a NG-RAN node receives multiple N2 message to release the MBS Session for the same TMGI (e.g. from several AMFs the NG-RAN is connected to), NG-RAN only performs step 5 and step 6 once.

5. The NG-RAN stops the PTM transmission.

6. If N3mb multicast transport has been used, the NG-RAN sends a Leave message (LL SSM) to stop the media stream to this NG-RAN node. If N3mb point-to-point transport has been used, the NG-RAN release its DL N3mb Tunnel Info. NG-RAN deletes its MBS Session Context.

7. The NG-RAN reports successful release of resources for the MBS Session by sending MBS Session Resource Release Response (TMGI) message(s) to the AMF(s).

8. The AMF sends Namf_MBSBroadcast_ContextRelease response (TMGI) to the MB-SMF.

9. The AF may start a TMGI de-allocation procedure (steps 11˜14 in FIG. 7.1.1.4-1, or steps 14˜17 in FIG. 7.1.1.5-1).

3GPP TR 23.700-47 V0.2.0 includes Solution #12 for the group message delivery over MBS broadcast.

The following italics content is a copy of clause 6.12 of 3GPP TR 23.700-47 V0.2.0.

### 6.12 Solution #12: Group Message Delivery

### 6.12.1 Introduction

This solution addresses the following aspect in Key Issue #4: Whether and how to enhance the MBS functionality to provide a similar group message delivery as available in eMBMS.

### 6.12.2 Functional Description

This solution describes a NEF-based group message delivery via MBS method, which is comparable to the SCEF-based group message delivery via MBMS.

This solution utilizes the Object Delivery Method in MBSTF specified in TS 26.502 for the group message delivery via MBS. The Object Delivery Method in MBSTF is equivalent to the File Delivery Method in eMBMS. The Object Delivery Method can benefit from Application Layer Forward Error Correction (AL-FEC) to achieve the reliable delivery, which is essential for group message delivery.

The NEF is responsible to handle Group Message Delivery request from the AF. It transforms the group message into a file and determine the meta data information of the file. In control plane, it performs Application Service Provisioning including MBS User Service creation and MBS User Data Ingest Session creation, which triggers the MBS session creation and MBS session start for broadcast towards 5GC and NR. In user plane, it is responsible for ingesting the file to the MBSTF, so that MBSTF can deliver the file to UE via 5GC shared traffic delivery and NR broadcast.

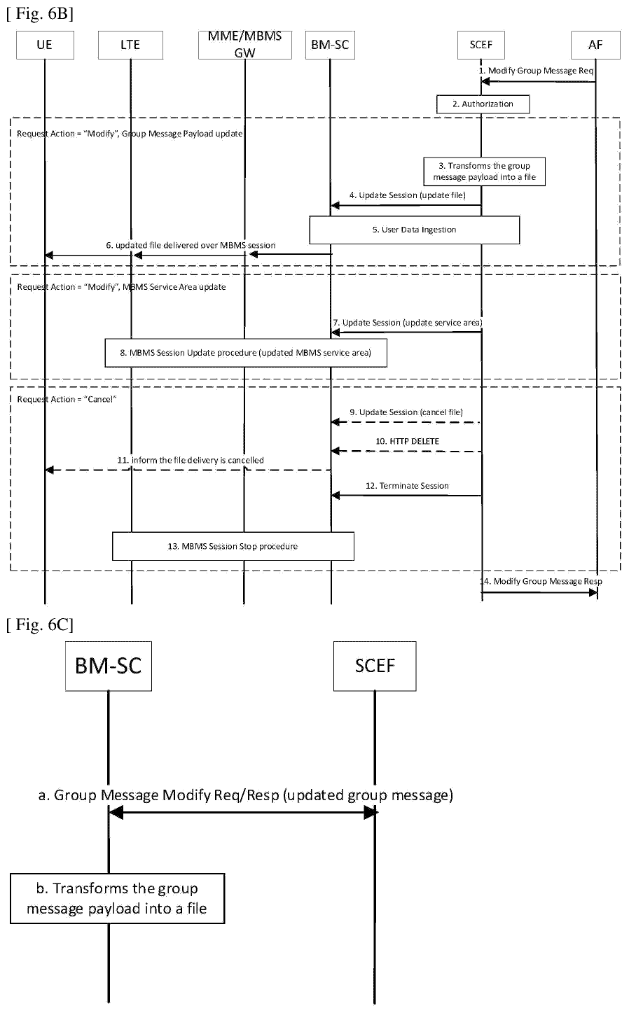

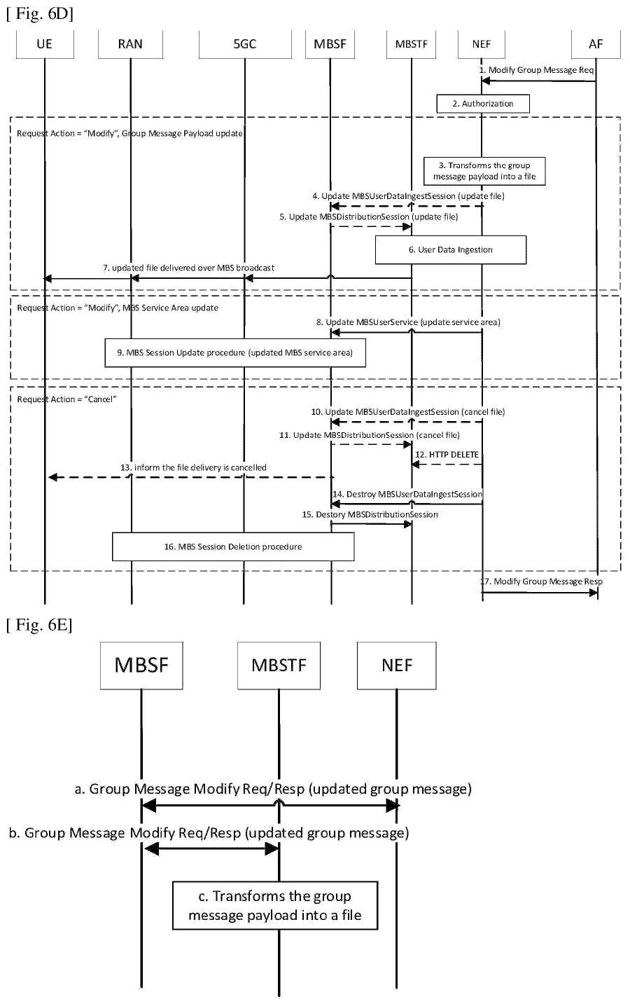

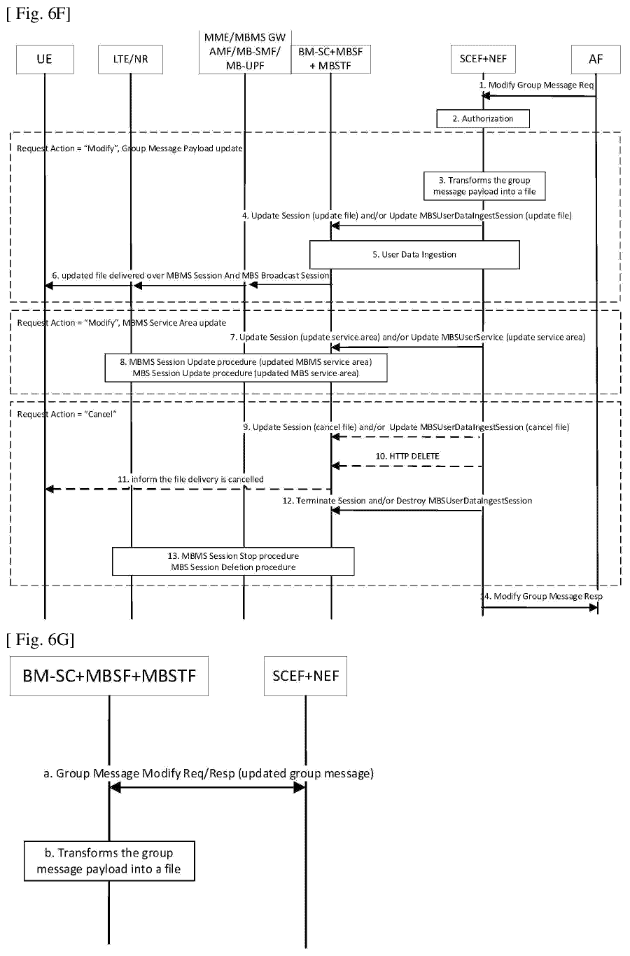

FIG. 1K shows a flowchart of Group Message Delivery via MBS Broadcast, which is same as FIG. 6.12.3.2-1 of 3GPP TR 23.700-47 V0.2.0.

The following italics content is a copy of clauses 6.12.3.2, 6.12.3.3 and 6.12.3.4 of 3GPP TR 23.700-47 V0.2.0.

1. The AF sends Group Message Request to the NEF, containing the Group Message Payload, MBS service area, Group Message Delivery Start Time, Stop Time.

Editor's note: The other parameters in Group Message Request is FFS.

2. The NEF checks authorization of AF. If geographical area information or civic address information was provided by the AF as MBS service area, the NEF translates the MBS service area to Cell ID list or TAI list.

NOTE 2: The NEF is mandated for group message delivery.

3. The NEF transforms the group message payload into a file, and determines the meta data information of the file (e.g. File URL, etc.).

If Application Service Provisioning hasn't been performed, step 4 to step 8 needs to be executed. Otherwise, they can be skipped.

4. The NEF performs Application Service Provisioning towards the MBSF as

specified in step 1 in clause 5.2 of TS 26.502, which including invoking Nmbsf_MBSUserService_Create and Nmbsf_MBSUserDataIngestSession_Create on the MBSF.

The Target service area is set to MBS Service Area.

The Distribution method is set to Object Distribution Method which is used for file delivery.

The Distribution Operating Mode is set to File or Carousel depends on the decision of the NEF.

The Object acquisition method is set to Push or Pull depends on the decision of the NEF.

5. The MBSF performs MBS Session Creation as specified in clause 7.1.1.2 or clause 7.1.1.3 of TS 23.247 [4].

6. The MBSF performs Distribution Session Provisioning as specified in step 2 in

clause 5.2 of TS 26.502. The MBSF invokes Nmbstf_MBSDistributionSession_C reate on the MBSTF, passing the parameters of the MBS Distribution Session received in step 4 to the MBSTF.

7. The MB-SMF initiates the MBS Session Start for Broadcast procedure as specified in step 2 to step 9 in clause 7.3.1 of TS 23.247 [4].

8. If the MBSF performs the service announcement, it initiates the MBS User Service

Announcement as specified in step 3 in clause 5.2 of TS 26.502. The application may receive the appropriate information through the MBS-6 API from the MBS Client (see TS 26.502).

Editor's note: How MBSF sends the service announcement information to the NEF which act as AF, depends on TS 26.502 defined by SA4.

9. The NEF sends Group Message Response to the AF. If the AF performs the service announcement, the service announcement information containing the file meta data can be optionally included in the Group Message Response.

10. If the AF needs to perform the Service Announcement, the AF sends the application service announcement to the UE as specified in step 4 in clause 5.2 of TS 26.502.

11. The NEF performs the User Data Ingestion towards the MBSTF as specified in

step 5 in clause 5.2 of TS 26.502. The NEF may push the file to the MBSTF or let MBSTF pull the file from the NEF.

12. The MBSTF performs packetization and optionally FEC encoding as specified in clause 4.3.3.2 of TS 26.502.

13. The MBSTF delivers the packets to the MB-UPF to NG-RAN, and NG-RAN broadcast to the UE as specified in step 13 to step 15 in clause 7.3.1 of TS 23.247 [4].

14. Based on the service announcement information received in step 8 or step 10, the UE receives the packets, is required performs FEC decoding to restore the file, and gets the group message from the file, using the MBS Client as specified in clause 4.3.5 of TS 26.502. The MBS Client can expose the file towards the application in the UE using the MBS-7 API (see TS 26.502).

### 6.12.3.3 Modification of Previously Submitted Group Message

Editor's note: It is FFS how the modification of previously submitted group message can be implemented.

### 6.12.4 Impacts on Services, Entities and Interfaces.

Functional entities defined in clause 5.3.2 of TS 23.247 [4] and clause 6.2 of TS 23.501 [2] are reused exception for the following additions:

### NEF:

Support group message delivery interface towards AF, and optionally include the service announcement information in the group message delivery response to the AF.
Transform the group message into a file and determine the meta data information of the file.
Create MBS User Service and MBS User Data Ingest Session to the MBSF.
Ingest file to the MBSTF.

Editor's note: Additional impacts are FFS.

FIG. 1L shows a flowchart of Modification of previously submitted Group Message, which is same as FIG. 5.5.2-1 of 3GPP TS 23.682 V17.2.0.

The following italics content is a copy of clause 5.5.2 of 3GPP TS 23.682 V17.2.0.

0. The pre-condition for this flow is the successful completion of step 11 from clause 5.5.1.

1. Application level interactions may be applied for the devices of specific group to retrieve the related MBMS service information, e.g. TMGI, start time, etc. in the case of MB2 or ServiceId in the case of xMB. When the application receives a ServiceId through application level interaction, the application can activate reception using

MBMS device APIs (see TS 26.347). Application level interactions between the UE and the SCS/AS are out of scope of this specification.

2. The SCS/AS determines that modification of previously accepted Group Message Delivery Request is required. The SCS/AS sends the Modify Group Message Request (TLTRI, Requested Action, Message Delivery Start Time, Message Delivery Stop Time (xMB only), optional (External Group Identifier, SCS Identifier, TMGI (MB2 only), Group Message Payload, location information, Accuracy) message to the SCEF. In the case of xMB, the SCEF identifies the associated MBMS Service using the external Group Identifier. Requested Action is either set to “Modify”, or “Cancel”. “Modify” indicates the request is to modify the transaction identified by TLTRI. “Cancel” indicates the request is to cancel the transaction identified by TLTRI. When set to “Modify”, then the remainder parameters, except Message Delivery Start Time, are optional, and included only if different to that of step 6 from clause 5.5.1. When set to “Cancel”, no other parameters are included.

3. The SCEF uses TLTRI to locate the context of previously accepted Group Message Delivery Request executed in clause 5.5.1. If no associated transaction is found, or if a transaction if found but step 13a from clause 5.5.1 was completed, then step 4 is executed with appropriate Cause value, and the flow stops at this step. Otherwise, the flow proceeds.

4. If Requested Action was set to “Cancel”, then if MB2 is used the mechanisms defined in clause 5.1.2.3.3 of TS 23.468 and if xMB is used the mechanisms defined in clause 5.4.5 of TS 26.348 are executed by the SCEF to release the associated MBMS resources. If Requested Action was set to “Modify”, then if MB2 is

used the mechanisms defined in clause 5.1.2.4 of TS 23.468 are used by the SCEF to modify the associated MBMS resources, whereas if xMB is used the mechanisms defined in clause 5.4.4 of TS 26.348 with the following changes:
In step 1 of this procedure, the SCEF, acting as GCS AS (if MB2 is used) or Content provider (if xMB is used), may include location information from step 2. If no location information is provided in step 2 of this procedure, then the SCEF, based on local configuration, uses either a list of MBMS Service Area Identities, or a list of cell IDs, or both as the MBMS broadcast area.
In step 2 of this procedure, the BM-SC may map the civic address(es) (if provided) and/or geographic area(s) (if provided) of location information into MBMS Service Arca Identities subject to operator policies.

5. If Requested Action was set to “Cancel”, then the SCEF sends a Modify Group Message Response (Cause) message to the SCS/AS with appropriate Cause value depending on whether the cancellation was accepted, and the flow stops at this step. If Requested Action was set to “Modify”, then the SCEF sends a Modify Group Message Response (Cause, TMGI, Acceptance Status) message to the SCS/AS to indicate whether the requested modifications were accepted. The usage of parameters is similar to step 11 of clause 5.5.1.

### 6. Steps 12-14 of Clause 5.5.1 are Executed.

3GPP TS 26.348 V16.3.0 specifies user plane for file delivery over xMB reference point as below:

### 5.5.2 File Distribution

Provisioning files for file distribution shall use one of the following options:
WebDAV as described in RFC 4918 [7] over HTTP over TLS. The Content Provider shall provide an authorization access token with every HTTPS transaction.
HTTP over TLS for file retrieval. The BM-SC shall use at least HTTP Version 1.1.

The content provider shall ensure that content is available at the BM-SC prior to its scheduled transmission time. For instance, for DASH segments, the segment shall be pushed to the BM-SC considering the timing requirements indicated in the MPD.

Also for all files that are declared as part of the file list of a session, all declared files shall be available before their indicated availability time, or if not provided, prior to the session start.

As an alternative to providing the properties and transport-related requirements of a file-based service, for delivery over the MBMS bearer service, via the ‘File List’ property of the ‘Session’ resource in subclause 5.4.6, the Content Provider may elect to convey the same information via the File Delivery Manifest, as described in clause 5.6.

As described above, there are some problems in the exiting group message modification and cancel solution. To overcome or mitigate at least one above mentioned problems or other problems, the embodiments of the present disclosure propose an improved solution for group message modification and cancel.

In an embodiment, the solution may cover 3 deployments:
Modify Group message using MBMS in EPS (Evolved Packet System) (also called “eMBMS”),
Modify Group message using MBS in 5GS,
Modify Group message using interworking between MBS and eMBMS.

In an embodiment, corresponding to the above deployment, AF sends group message delivery message to SCEF, NEF, or SCEF+NEF (a combined SCEF and NEF) respectively.

In an embodiment, when group message is modified, in MBS deployment in 5GS, the system may behave as follows:

1-1 NEF transforms the group message payload into a file with the same file URI (Uniform Resource Identifier) as the previous group message.

1-2 NEF delivers the updated file to MBSTF via 2 options:

Option 1: NEF encapsulates the group message into a file,
Option 1.1: NEF pushes the file to MBSTF via WebDAV (Web-based Distributed Authoring and Versioning) ingestion.
Option 1.2: NEF indicates the update of the file to MBSF. MBSF sends to MBSTF, and MBSTF pulls the file from NEF via HTTP(s). It is possible that NEF uploads it to an HTTP (Hyper Text Transfer Protocol) server and MBSTF downloads from the HTTP server.

Option 2: NEF sends the updated group message to MBSF (e.g. in a modify group message request). MBSF sends the updated group message to MBSTF.

1-3 MBSTF receives the updated file and encodes the file (include FEC encoding) and delivers the packetized file (ROUTE or FLUTE) to MB-UPF. And then, 5GC can deliver the packetized file towards UE over MBS broadcast via NG-RAN. ROUTE denotes Real-time Transport Object delivery over Unidirectional Transport. FLUTE denotes File Delivery over Unidirectional Transport. FEC denotes Forward Error Correction.

In an embodiment, when group message is modified, in eMBMS deployment, the system may behave as follows:
Same as 1-1 above, except that SCEF is used instead of NEF,
Same as 1-2 above, except that SCEF is used instead of NEF and BM-SC is used instead of MBSF and MBSTF,
BM-SC encode the file (include FEC encoding) and deliver the packetized file (FLUTE) to MBMS-GW to E-UTRAN. E-UTRAN broadcast over Uu.

In an embodiment, when group message is modified, in deployment with interworking between MBS and eMBMS, compared to MBS deployment in 5GS,
Same as 1-1 above, except that NEF+SCEF is used instead of NEF
Same as 1-2 above, except that NEF+SCEF is used instead of NEF, and BM-SC+MBSF+MBSTF is used instead of MBSF and MBSTF
BM-SC+MBSF+MBSTF utilize the “file delivery” function to encode the updated file (include FEC encoding). The packetized file is delivered from BM-SC+MBSF+MBSTF to E-UTRAN via EPC and to NG-RAN via 5GC separately.

In an embodiment, when group message is cancelled, in MBS deployment in 5GS, the system behaves as follows:

2-1 NEF indicates the cancellation towards MBSTF via 2 options:
Option 1: NEF indicates the cancellation of the file to the MBSF. MBSF sends to MBSTF.
Option 2: NEF sends HTTP DELETE to MBSTF

2-2 The MBSTF stops the file delivery and informs the MBS Client the cancellation if needed.

2-3 NEF destroys the MBS User Data Ingest session towards MBSF. The MBSF destroys the MBS Distribution Session towards MBSTF, and triggers MBS session deletion in 5GC and NR.

In an embodiment, when group message is cancelled, in eMBMS deployment, the system behaves as follows:

Same as 2-1 above, except that SCEF is used instead of NEF and BM-SC is used instead of MBSF and MBSTF

Same as 2-2 above, except that BM-SC stops the file delivery and informs the MBMS Client via in-band fragment delivery or out-band

Same as 2-3 above, except that BM-SC stops MBMS session in EPC and LTE.

In an embodiment, when group message is cancelled, in deployment with interworking between MBS and eMBMS, compared to MBS deployment in 5GS,

Same as 2-1 above, except that NEF+SCEF is used instead of NEF

Same as 2-2 above, except that BM-SC+MBSF+MBSTF stops the file delivery and informs MBMS Client and MBS client separately.

Same as 2-3 above, except that BM-SC+MBSF+MBSTF stops MBMS session in EPC and LTE, as well as stops MBS session in 5GC and NR.

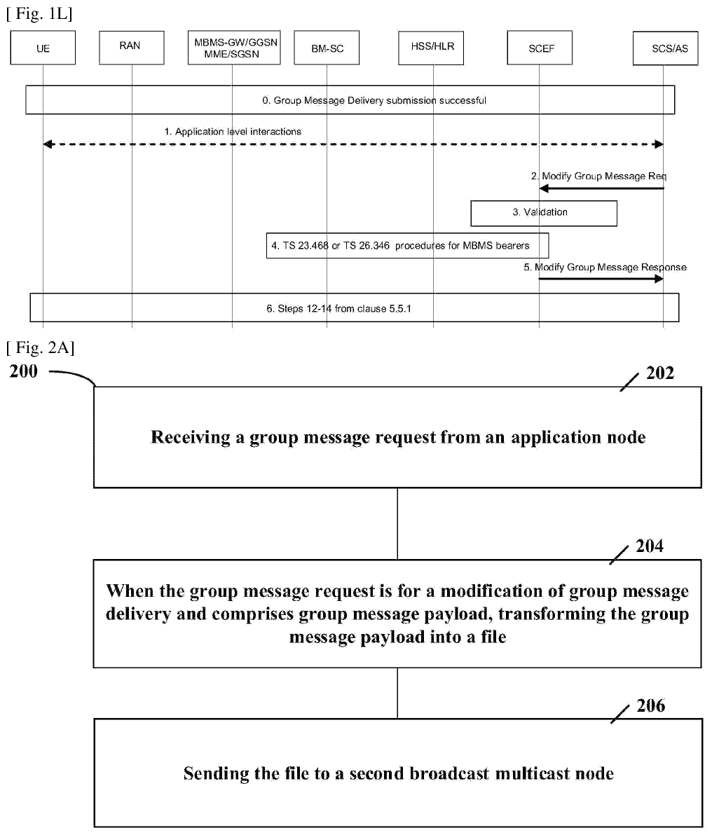

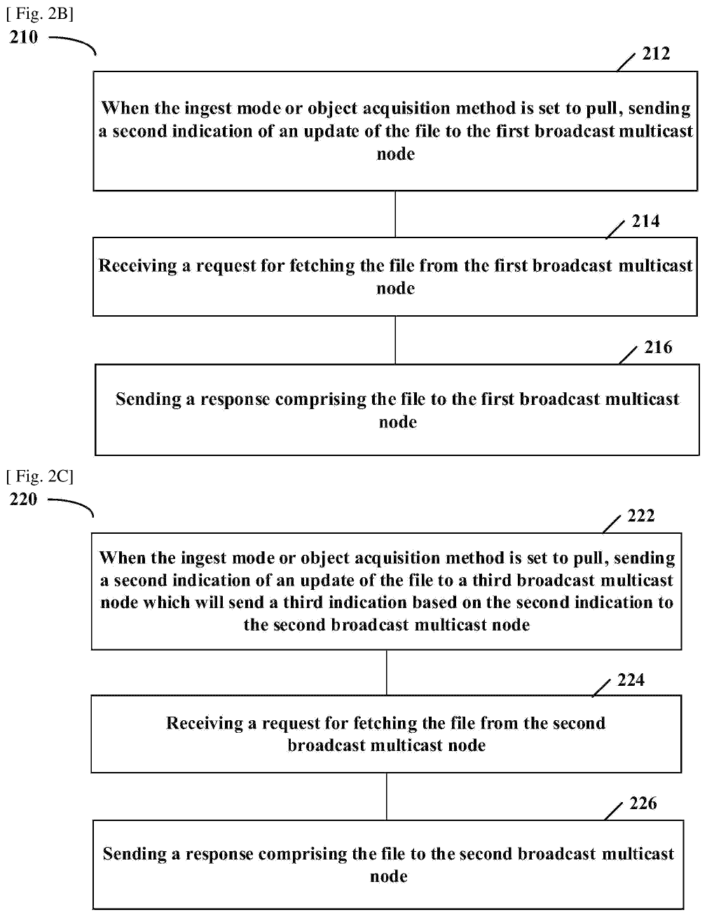

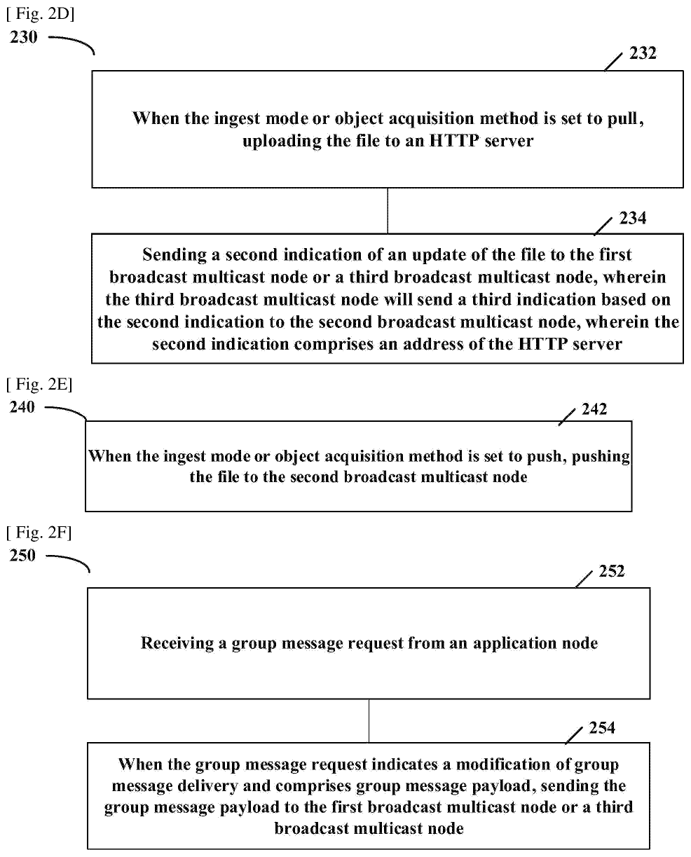

FIG. 2A shows a flowchart of a method according to an embodiment of the present disclosure, which may be performed by an apparatus implemented in/as or communicatively coupled to an exposure node. As such, the apparatus may provide means for accomplishing various parts of the method 200 as well as means for accomplishing other processes in conjunction with other components.

At block 202, the exposure node may receive a group message request from an application node.

The application node may be any suitable node which can provide similar or same function as the AF as described in 3GPP TS 23.501 V17.1.1 or the Application Server (AS) or Services Capability Server (SCS) as described in 3GPP TS 23.682 V17.2.0. For example, the application node may be a content provider or a multicast source or a broadcast source.

In an embodiment, the application node comprises AF as described in 3GPP TS 23.501 V17.1.1.

In an embodiment, the application node comprises AS/SCS as described in 3GPP TS 23.682 V17.2.0.

The exposure node may be any suitable network function which can provide similar or same function as the NEF, SCEF, a combined SCEF and NEF as described in 3GPP TS 23.501 V17.1.1 and 3GPP TS 23.682 V17.2.0.

In an embodiment, the exposure node comprises at least one of a Network Exposure Function (NEF), a Service Capability Exposure Function (SCEF), or a combined NEF and SCEF.

The group message request may be any suitable message which can used to modify or cancel group message delivery transaction.

In an embodiment, the group message request may comprise a modify group message request with a requested action set to modify or cancel as described in 3GPP TS 23.682 V17.2.0.

In an embodiment, the group message request may comprise a modify group message request or a cancel group message request.

The group message request may comprise any suitable parameters. For example, the group message request may Request Action, Group Message Payload, MBS service area, Group Message Delivery Start Time, Stop Time, External Group Identifier, etc. The exposure node such as NEF may identify the associated MBS Service using the external Group Identifier. Requested Action is either set to “Modify”, or “Cancel”. “Modify” indicates the request is to modify the group message delivery transaction. “Cancel” indicates the request is to cancel the group message delivery transaction.

At block 204, when the group message request is for (or indicates) a modification of group message delivery and comprises group message payload, the exposure node may transform the group message payload into a file. For example, the exposure node such as NEF transforms the group message payload (or group message) into a file. The exposure node such as NEF determines meta data information of the file (e.g. File URL, or File URI, etc.). The file can refer to file object or object under the context of the services offered by MBSF and/or MBSTF, etc.

In an embodiment, the determined file meta data (e.g., in a group message delivery procedure) is used as meta data information of the file. For example, the file meta data of an original file (e.g., the current file to be delivered or being delivering) may be used as meta data information of the file.

In an embodiment, the determined file meta data comprises a file uniform resource locator (URL) and/or a file uniform resource identifier (URI). The file URI or URL can be used to identify the file. The file URI or URL can be used by BM-SC/MBSTF/UE to download the file.

At block 206, the exposure node may send the file to a second broadcast multicast node.

In an embodiment, the exposure node may send the file to a first broadcast multicast node.

The first broadcast multicast node may be any suitable network function which can provide similar or same function as Broadcast Multicast Service Centre (BM-SC) or a combined BM-SC, Multicast/Broadcast Service Function (MBSF) and Multicast/Broadcast Service Transport Function (MBSTF) as described in 3GPP TS 23.247 V17.2.0 or 3GPP TS 23.682 V17.2.0.

In an embodiment, the first broadcast multicast node comprises at least one of BM-SC, or a combined BM-SC, MBSF and MBSTF.

The second broadcast multicast node may be any suitable network function which can provide similar or same function as MBSTF as described in 3GPP TS 23.247 V17.2.0.

In an embodiment, the second broadcast multicast node comprises an MBSTF.

The exposure node may send the file to a first broadcast multicast node or a second broadcast multicast node in various ways and the present disclosure has no limit on it. For example, the exposure node may send the file to a first broadcast multicast node or a second broadcast multicast node directly or via another network node. The exposure node may send the file to a first broadcast multicast node or a second broadcast multicast node in response to a request from the first broadcast multicast node or the second broadcast multicast node. The exposure node may push the file to the first broadcast multicast node or the second broadcast multicast node.

FIG. 2B shows a flowchart of a method according to another embodiment of the present disclosure, which may be performed by an apparatus implemented in/as or communicatively coupled to an exposure node. As such, the apparatus may provide means for accomplishing various parts of the method 210 as well as means for accomplishing other processes in conjunction with other components. For some parts which have been described in the above embodiments, the description thereof is omitted here for brevity.

In this embodiment, when the ingest mode or object acquisition method is set to pull, the exposure node may send the file to the first broadcast multicast node as follows.

At block 212, the exposure node may send a second indication of an update of the file to the first broadcast multicast node.

In an embodiment, the second indication is a property or a parameter with a refresh or update value within session parameters to inform the first or second broadcast multicast node about the refresh of the file.

At block 214, the exposure node may receive a request for fetching the file from the first broadcast multicast node.

At block 216, the exposure node may send a response comprising the file to the first broadcast multicast node.

For example, if Ingest Mode is Pull, the exposure node such as SCEF invokes Update Session towards the first broadcast multicast node such as BM-SC, which indicating an update of the file. The indication may be a property with the refresh or update value within the Session parameters to inform the first broadcast multicast node such as BM-SC about the refresh of the file. The file can also be included in a file list. If Ingest Mode is Pull, the first broadcast multicast node such as BM-SC pulls the file from the exposure node such as SCEF.

As another example, the exposure node such as SCEF indicates the update of the file to the first broadcast multicast node such as BM-SC. The exposure node such as SCEF uploads the file to an HTTP server and the first broadcast multicast node such as BM-SC downloads the file from the HTTP server.

FIG. 2C shows a flowchart of a method according to another embodiment of the present disclosure, which may be performed by an apparatus implemented in/as or communicatively coupled to an exposure node. As such, the apparatus may provide means for accomplishing various parts of the method 220 as well as means for accomplishing other processes in conjunction with other components. For some parts which have been described in the above embodiments, the description thereof is omitted here for brevity.

In this embodiment, when the ingest mode or object acquisition method is set to pull, the exposure node may send the file to the second broadcast multicast node as follows.

At block 222, the exposure node may send a second indication of an update of the file to a third broadcast multicast node which will send a third indication based on the second indication to the second broadcast multicast node.

In an embodiment, the second indication is a property or a parameter with a refresh or update value within session parameters to inform the first or second broadcast multicast node about the refresh of the file.

The third broadcast multicast node may be any suitable network function which can provide similar or same function as Broadcast Service Function (MBSF) as described in 3GPP TS 23.247 V17.2.0.

In an embodiment, the third broadcast multicast node comprises an MBSF.

At block 224, the exposure node may receive a request for fetching the file from the second broadcast multicast node.

At block 226, the exposure node may send a response comprising the file to the second broadcast multicast node.

For example, if Object acquisition method is set to Pull, the exposure node such as NEF invokes Update MBS User Data Ingest Session (Nmbsf_MBSUserDataIngestSess ion_Update) on the third broadcast multicast node such as MBSF. The update service operation indicates an update of the file containing the updated group message. The indication may be a property with the refresh or update value within the MBS Distribution Session parameter to inform the second/third broadcast multicast node about the refresh of the file. The file can also be included in a file list. The third broadcast multicast node such as MBSF invokes Update MBS Distribution Session (Nmbstf_MBSDistributionSession_Update) on the second broadcast multicast node such as MBSTF. The update service operation indicates an update of the file containing the updated group message. The indication may be a property with the refresh or update value within the MBS Distribution Session parameter to inform the second/third broadcast multicast node about the refresh of the file. The file can also be included in a file list.

FIG. 2D shows a flowchart of a method according to another embodiment of the present disclosure, which may be performed by an apparatus implemented in/as or communicatively coupled to an exposure node. As such, the apparatus may provide means for accomplishing various parts of the method 230 as well as means for accomplishing other processes in conjunction with other components. For some parts which have been described in the above embodiments, the description thereof is omitted here for brevity.

In this embodiment, when the ingest mode or object acquisition method is set to pull, the exposure node may send the file to the first broadcast multicast node or the second broadcast multicast node as follows.

At block 232, the exposure node may upload the file to an HTTP server.

At block 234, the exposure node may send a second indication of an update of the file to the first broadcast multicast node or a third broadcast multicast node. The third broadcast multicast node will send a third indication based on the second indication to the second broadcast multicast node. The second indication comprises an address of the HTTP server.

For example, the exposure node such as NEF/SCEF indicates the update of the file to the first/third broadcast multicast node. And the third broadcast multicast node such as MBSF indicates the update of the file to the second broadcast multicast node such as MBSTF. The exposure node such as NEF/SCEF uploads the file to an HTTP server and the first/second broadcast multicast node downloads the file from the HTTP server.

In an embodiment, the exposure node may upload the file to an HTTP server. The second indication may comprise an address of a HTTP server storing the file. The first or second broadcast multicast node may download the file from the HTTP server.

FIG. 2E shows a flowchart of a method according to another embodiment of the present disclosure, which may be performed by an apparatus implemented in/as or communicatively coupled to an exposure node. As such, the apparatus may provide means for accomplishing various parts of the method 240 as well as means for accomplishing other processes in conjunction with other components. For some parts which have been described in the above embodiments, the description thereof is omitted here for brevity.

In this embodiment, when the ingest mode or object acquisition method is set to push, the exposure node may send the file to the first broadcast multicast node or the second broadcast multicast node as follows.

At block 242, the exposure node may push the file to the second broadcast multicast node.

In an embodiment, the exposure node may push the file to the first broadcast multicast node.

In an embodiment, the file is included in a file list.

In an embodiment, after receiving the group message request from the application node, the exposure node such as SCEF may check authorization of AF. The exposure node such as SCEF may translate location information to either a list of MBMS Service Area Identities, or a list of cell IDs, or both as the MBMS broadcast area.

In an embodiment, after receiving the group message request from the application node, the exposure node such as NEF may check authorization of AF. If geographical area information or civic address information was provided by the AF as MBS service area, the exposure node such as NEF translates the MBS service area to Cell ID (identifier) list or TAI list.

FIG. 2F shows a flowchart of a method according to another embodiment of the present disclosure, which may be performed by an apparatus implemented in/as or communicatively coupled to an exposure node. As such, the apparatus may provide means for accomplishing various parts of the method 240 as well as means for accomplishing other processes in conjunction with other components. For some parts which have been described in the above embodiments, the description thereof is omitted here for brevity.

At block 252, the exposure node may receive a group message request from an application node. Block 252 is same as block 202 of FIG. 2A.

At block 254, when the group message request is for a modification of group message delivery and comprises group message payload, the exposure node may send the group message payload to the first broadcast multicast node or a third broadcast multicast node.

For example, the NEF sends the group message modify request with updated group message to the MBSF. The MBSF responds the NEF. The MBSF sends the group message modify request with the updated group message to the MBSTF. The MBSTF responds the MBSF. The MBSTF transforms the updated group message into a file.

As another example, the SCEF sends the group message modify request with the updated group message (i.e., group message payload) to the BM-SC. The BM-SC responds the SCEF. The BM-SC transforms the updated group message into a file.

FIG. 2G shows a flowchart of a method according to another embodiment of the present disclosure, which may be performed by an apparatus implemented in/as or communicatively coupled to an exposure node. As such, the apparatus may provide means for accomplishing various parts of the method 260 as well as means for accomplishing other processes in conjunction with other components. For some parts which have been described in the above embodiments, the description thereof is omitted here for brevity.

At block 262, the exposure node may receive a group message request from an application node. Block 262 is same as block 202 of FIG. 2A.

At block 264, optionally, when the group message request is for (e.g. indicates) a cancellation of group message delivery, the exposure node may send a first indication of a cancel of a file delivery to the third broadcast multicast node.

In an embodiment, the ingest mode or object acquisition method may be set to pull.

In an embodiment, when the group message request is for a cancellation of group message delivery and when the ingest mode or object acquisition method is set to pull, the exposure node may send a first indication of a cancel of a file delivery to the first broadcast multicast node or the third broadcast multicast node.

At block 266, optionally, when the group message request is for (e.g. indicates) a cancellation of group message delivery, the exposure node may send an HTTP DELETE to the second broadcast multicast node to cancel file delivery.

In an embodiment, the ingest mode or object acquisition method may be set to push.

In an embodiment, when the group message request is for a cancellation of group message delivery and when the ingest mode or object acquisition method is set to push, the exposure node may send an HTTP DELETE to the first broadcast multicast node or the second broadcast multicast node to cancel file delivery.

In an embodiment, the first indication is a property or a parameter with a cancel value (e.g., within session parameters) to inform the first broadcast multicast node or the second broadcast multicast node about cancel of file delivery.

For example, if ingest Mode is set to Pull, the SCEF invokes Update Session on the BM-SC. The update service operation indicates the cancel of the file delivery. The update session operation indicates the cancel of the file delivery. The indication may be a property with a cancel value within the Session parameter to inform the BM-SC about the cancellation of the file. The file can also be included in a file list. If Ingest Mode is set to Push, the SCEF sends HTTP DELETE to the BM-SC to cancel the file delivery. The BM-SC stops the file delivery and informs the MBMS Client the cancellation if needed. The cancellation can be included in the Schedule Fragment which is delivered in-band of the MBMS session or out-band.

As another example, if Object acquisition method is set to Pull, the NEF invokes Update MBS User Data Ingest Session (Nmbsf_MBSUserDataIngestSession_Update) on the MBSF. The update service operation indicates the cancel of the file delivery. The indication may be a property with a cancel value within the MBS Distribution Session parameter to inform the MBSF about the cancellation of the file. The file can also be included in a file list. The MBSF invokes Update MBS Distribution Session (Nmbstf_MBSDistributionSession_Update) on the MBSTF. The update service operation indicates the cancel of the file delivery. The indication may be a property with a cancel value within the MBS Distribution Session parameter to inform the MBSF about the cancellation of the file. The file can also be included in a file list. If Object acquisition method is set to Push, the NEF sends HTTP DELETE to the MBSTF to cancel the file delivery. The MBSTF stops the file delivery and informs the MBS Client the cancellation if needed, which can be in-band delivered within the MBS broadcast session to the MBS Client or out-band.

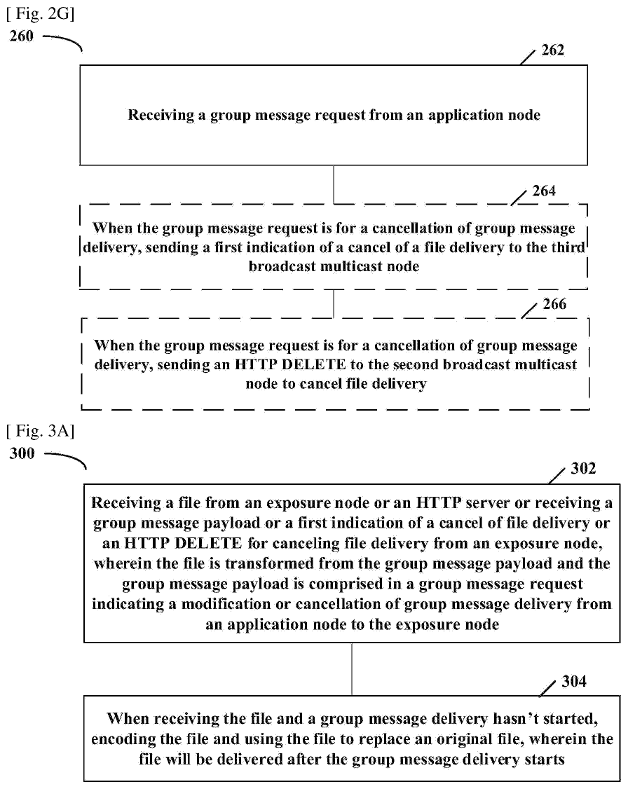

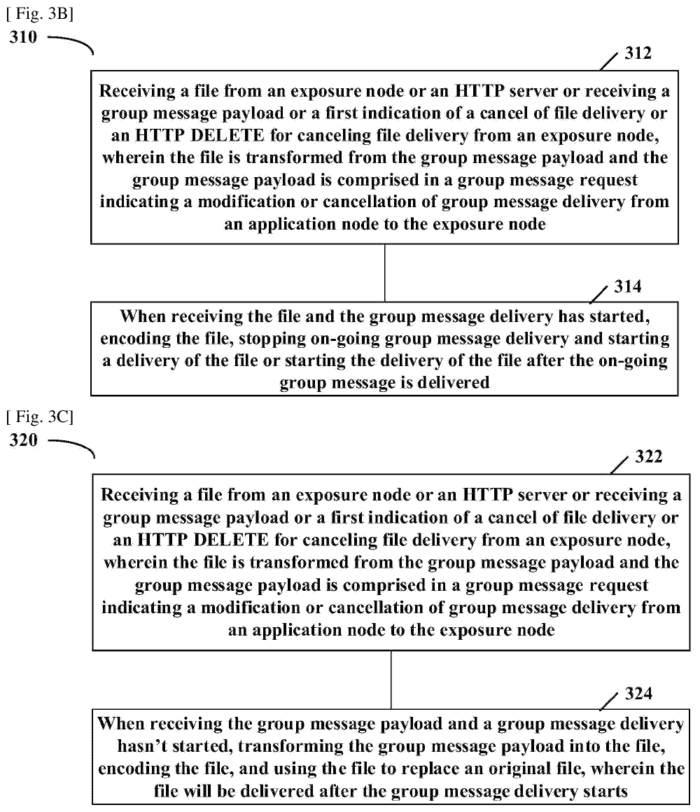

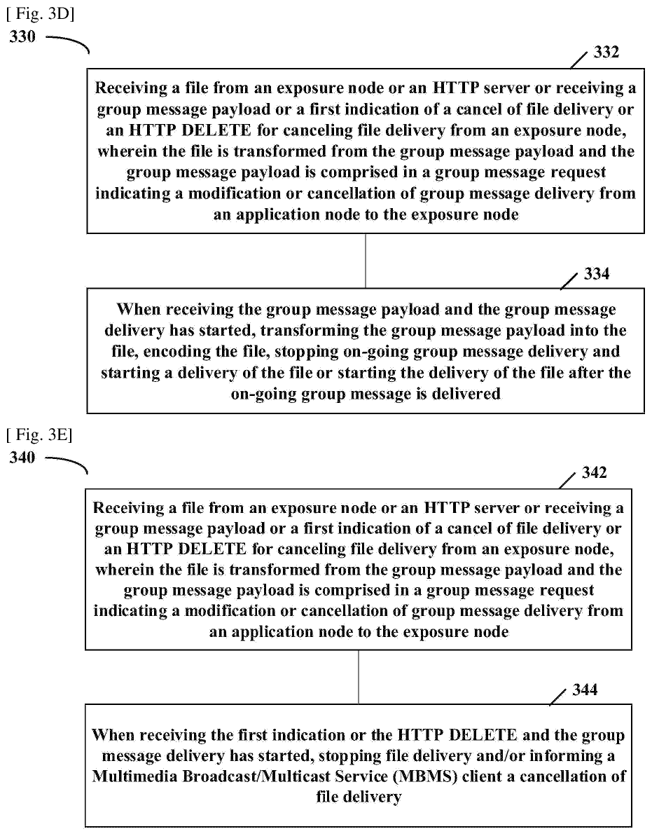

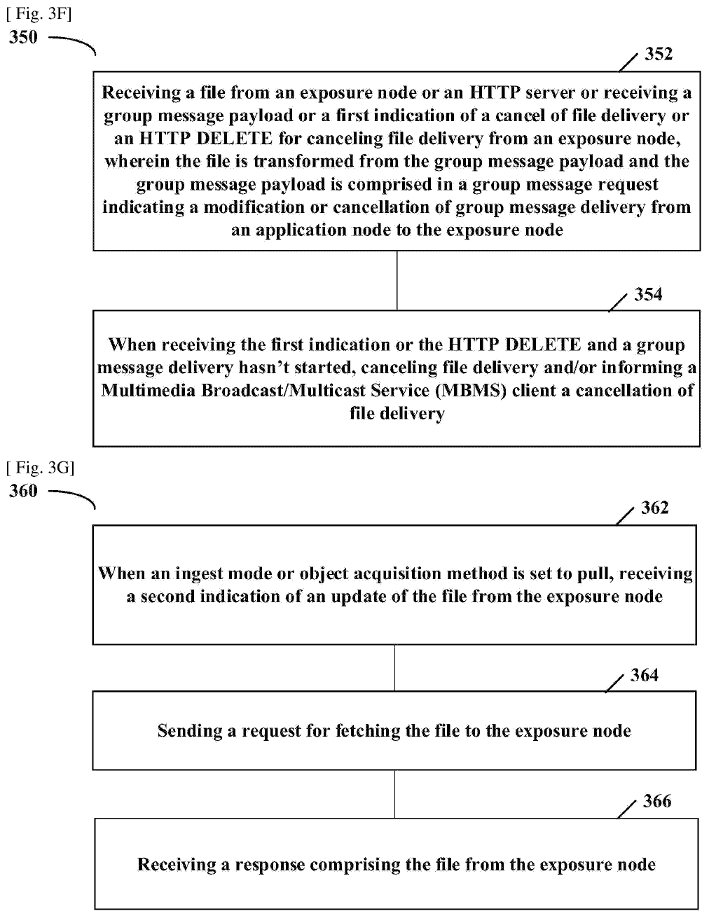

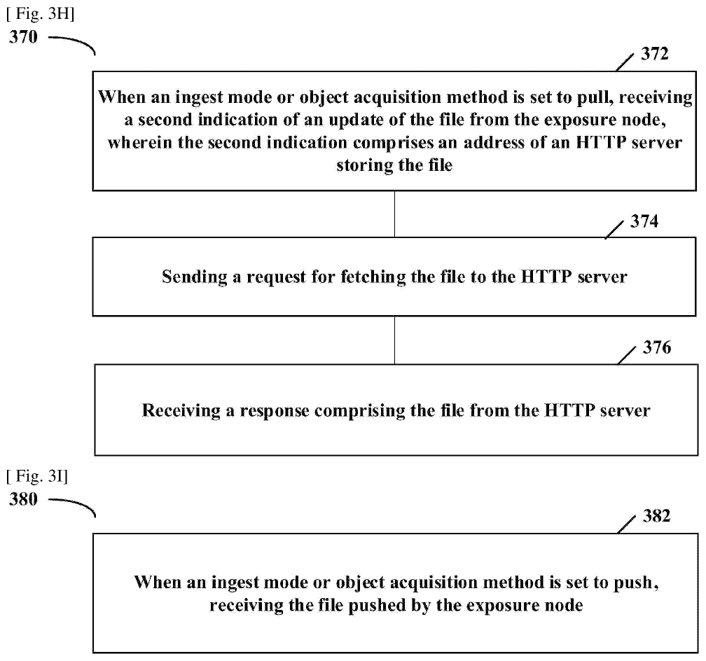

FIG. 3A shows a flowchart of a method according to another embodiment of the present disclosure, which may be performed by an apparatus implemented in/as or communicatively coupled to a first broadcast multicast node. As such, the apparatus may provide means for accomplishing various parts of the method 300 as well as means for accomplishing other processes in conjunction with other components. For some parts which have been described in the above embodiments, the description thereof is omitted here for brevity.

At block 302, the first broadcast multicast node may receive a file from an exposure node or an HTTP server or receiving a group message payload or a first indication of a cancel of file delivery or an HTTP DELETE for canceling file delivery from an exposure node. The file is transformed from the group message payload and the group message payload is comprised in a group message request indicating a modification or cancellation of group message delivery from an application node to the exposure node.

At block 304, when receiving the file and a group message delivery hasn't started, the first broadcast multicast node may encode the file and use the file to replace an original file. The file will be delivered after the group message delivery starts.

Encoding the file may comprise performing packetization and optionally FEC (Forward Error Correction) encoding for the file.

In an embodiment, determined file meta data (e.g. in a group message delivery procedure) is used as meta data information of the file.

In an embodiment, the determined file meta data comprises a file uniform resource locator (URL) and/or a file uniform resource identifier (URI).

FIG. 3B shows a flowchart of a method according to another embodiment of the present disclosure, which may be performed by an apparatus implemented in/as or communicatively coupled to a first broadcast multicast node. As such, the apparatus may provide means for accomplishing various parts of the method 310 as well as means for accomplishing other processes in conjunction with other components. For some parts which have been described in the above embodiments, the description thereof is omitted here for brevity.

At block 312, the first broadcast multicast node may receive a file from an exposure node or an HTTP server or receiving a group message payload or a first indication of a cancel of file delivery or an HTTP DELETE for canceling file delivery from an exposure node. The file is transformed from the group message payload and the group message payload is comprised in a group message request indicating a modification or cancellation of group message delivery from an application node to the exposure node.

At block 314, when receiving the file and the group message delivery has started, the first broadcast multicast node may encode the file, stop on-going group message delivery and start a delivery of the file or start the delivery of the file after the on-going group message is delivered.

FIG. 3C shows a flowchart of a method according to another embodiment of the present disclosure, which may be performed by an apparatus implemented in/as or communicatively coupled to a first broadcast multicast node. As such, the apparatus may provide means for accomplishing various parts of the method 320 as well as means for accomplishing other processes in conjunction with other components. For some parts which have been described in the above embodiments, the description thereof is omitted here for brevity.

At block 322, the first broadcast multicast node may receive a file from an exposure node or an HTTP server or receiving a group message payload or a first indication of a cancel of file delivery or an HTTP DELETE for canceling file delivery from an exposure node. The file is transformed from the group message payload and the group message payload is comprised in a group message request indicating a modification or cancellation of group message delivery from an application node to the exposure node.

At block 324, when receiving the group message payload and a group message delivery hasn't started, the first broadcast multicast node may transform the group message payload into the file, encode the file, and use the file to replace an original file. The file will be delivered after the group message delivery starts.

FIG. 3D shows a flowchart of a method according to another embodiment of the present disclosure, which may be performed by an apparatus implemented in/as or communicatively coupled to a first broadcast multicast node. As such, the apparatus may provide means for accomplishing various parts of the method 330 as well as means for accomplishing other processes in conjunction with other components. For some parts which have been described in the above embodiments, the description thereof is omitted here for brevity.

At block 332, the first broadcast multicast node may receive a file from an exposure node or an HTTP server or receiving a group message payload or a first indication of a cancel of file delivery or an HTTP DELETE for canceling file delivery from an exposure node. The file is transformed from the group message payload and the group message payload is comprised in a group message request indicating a modification or cancellation of group message delivery from an application node to the exposure node.

At block 334, when receiving the group message payload and the group message delivery has started, the first broadcast multicast node may transform the group message payload into the file, encode the file, stop on-going group message delivery and start a delivery of the file or start the delivery of the file after the on-going group message is delivered.

FIG. 3E shows a flowchart of a method according to another embodiment of the present disclosure, which may be performed by an apparatus implemented in/as or communicatively coupled to a first broadcast multicast node. As such, the apparatus may provide means for accomplishing various parts of the method 340 as well as means for accomplishing other processes in conjunction with other components. For some parts which have been described in the above embodiments, the description thereof is omitted here for brevity.

At block 342, the first broadcast multicast node may receive a file from an exposure node or an HTTP server or receiving a group message payload or a first indication of a cancel of file delivery or an HTTP DELETE for canceling file delivery from an exposure node. The file is transformed from the group message payload and the group message payload is comprised in a group message request indicating a modification or cancellation of group message delivery from an application node to the exposure node.

At block 344, when receiving the first indication or the HTTP DELETE and the group message delivery has started, the first broadcast multicast node may stop file delivery and/or informing a Multimedia Broadcast/Multicast Service (MBMS) client a cancellation of file delivery.

In an embodiment, the cancellation is comprised in a schedule fragment which is delivered in-band of a Multimedia Broadcast/Multicast Service (MBMS) session or out-band of the MBMS session to at least one MBMS client.

FIG. 3F shows a flowchart of a method according to another embodiment of the present disclosure, which may be performed by an apparatus implemented in/as or communicatively coupled to a first broadcast multicast node. As such, the apparatus may provide means for accomplishing various parts of the method 350 as well as means for accomplishing other processes in conjunction with other components. For some parts which have been described in the above embodiments, the description thereof is omitted here for brevity.

At block 352, the first broadcast multicast node may receive a file from an exposure node or an HTTP server or receiving a group message payload or a first indication of a cancel of file delivery or an HTTP DELETE for canceling file delivery from an exposure node. The file is transformed from the group message payload and the group message payload is comprised in a group message request indicating a modification or cancellation of group message delivery from an application node to the exposure node.

At block 354, when receiving the first indication or the HTTP DELETE and a group message delivery hasn't started, the first broadcast multicast node may cancel file delivery and/or inform a Multimedia Broadcast/Multicast Service (MBMS) client a cancellation of file delivery.

In an embodiment, the cancellation is comprised in a schedule fragment which is delivered in-band of a Multimedia Broadcast/Multicast Service (MBMS) session or out-band of the MBMS session to at least one MBMS client.

FIG. 3G shows a flowchart of a method according to another embodiment of the present disclosure, which may be performed by an apparatus implemented in/as or communicatively coupled to a first broadcast multicast node. As such, the apparatus may provide means for accomplishing various parts of the method 360 as well as means for accomplishing other processes in conjunction with other components. For some parts which have been described in the above embodiments, the description thereof is omitted here for brevity.

In an embodiment, when an ingest mode or object acquisition method is set to pull, the first broadcast multicast node may receive the file from the exposure node as following.

At block 362, the first broadcast multicast node may receive a second indication of an update of the file from the exposure node.

In an embodiment, the second indication is a property or a parameter with a refresh or update value within session parameters to inform the first broadcast multicast node about the refresh of the file.

At block 364, the first broadcast multicast node may send a request for fetching the file to the exposure node.

At block 366, the first broadcast multicast node may receive a response comprising the file from the exposure node.

FIG. 3H shows a flowchart of a method according to another embodiment of the present disclosure, which may be performed by an apparatus implemented in/as or communicatively coupled to a first broadcast multicast node. As such, the apparatus may provide means for accomplishing various parts of the method 370 as well as means for accomplishing other processes in conjunction with other components. For some parts which have been described in the above embodiments, the description thereof is omitted here for brevity.

In an embodiment, when an ingest mode or object acquisition method is set to pull, the first broadcast multicast node may receive the file from the HTTP server as following.

At block 372, the first broadcast multicast node may receive a second indication of an update of the file from the exposure node. The second indication comprises an address of an HTTP server storing the file.

In an embodiment, the second indication is a property or a parameter with a refresh or update value within session parameters to inform the first broadcast multicast node about the refresh of the file.

At block 374, the first broadcast multicast node may send a request for fetching the file to the HTTP server.

At block 376, the first broadcast multicast node may receive a response comprising the file from the HTTP server.

FIG. 3I shows a flowchart of a method according to another embodiment of the present disclosure, which may be performed by an apparatus implemented in/as or communicatively coupled to a first broadcast multicast node. As such, the apparatus may provide means for accomplishing various parts of the method 380 as well as means for accomplishing other processes in conjunction with other components. For some parts which have been described in the above embodiments, the description thereof is omitted here for brevity.

In an embodiment, when an ingest mode or object acquisition method is set to push, the first broadcast multicast node may receive the file from the exposure node as following.

At block 382, the first broadcast multicast node may receive the file pushed by the exposure node.

In an embodiment, the file is included in a file list.

In an embodiment, the first indication is a property or a parameter with a cancel value (e.g. within session parameters) to inform the first broadcast multicast node about cancel of file delivery.

In an embodiment, the exposure node comprises a SCEF or a combined NEF and SCEF.

In an embodiment, the first broadcast multicast node comprises a BM-SC or a combined BM-SC, MBSF and MBSTF.

In an embodiment, the group message request comprises a modify group message request with a requested action set to modify or cancel.

In an embodiment, the group message request comprises a modify group message request or a cancel group message request.

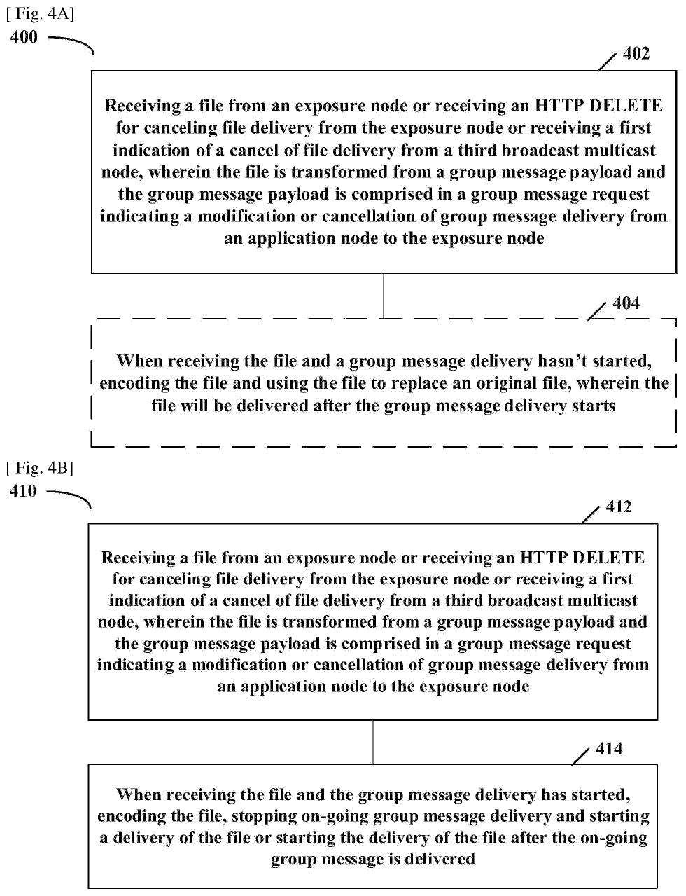

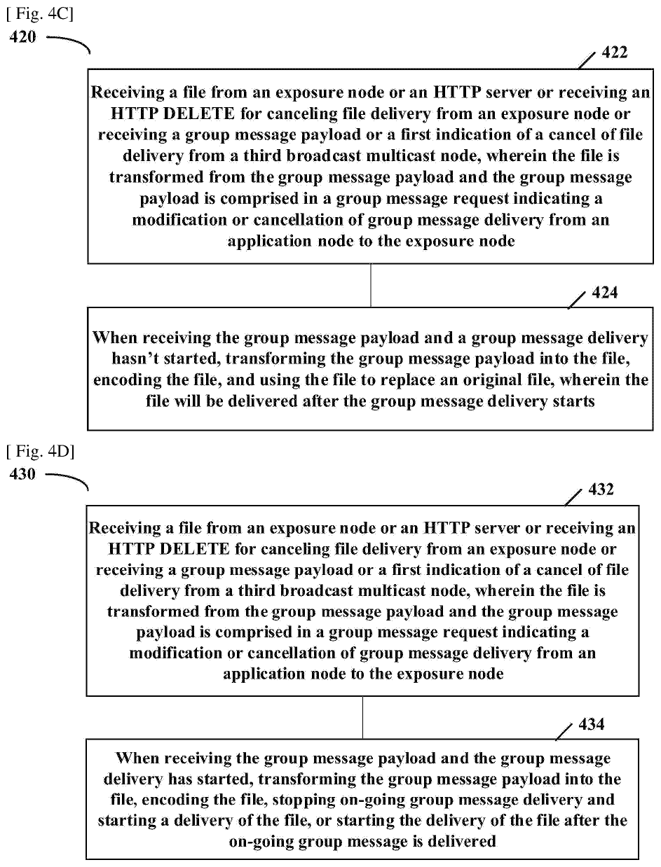

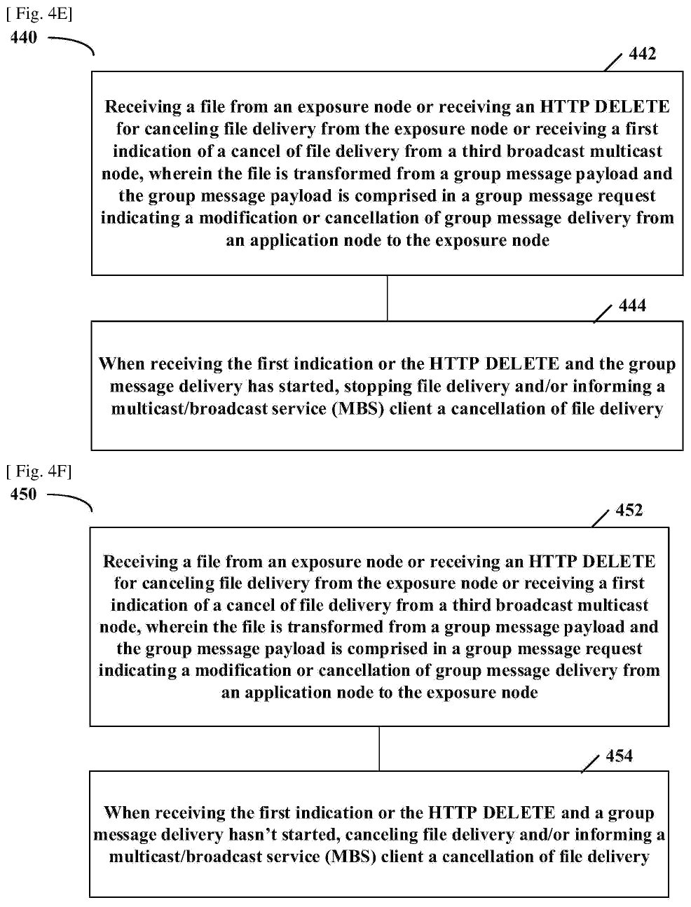

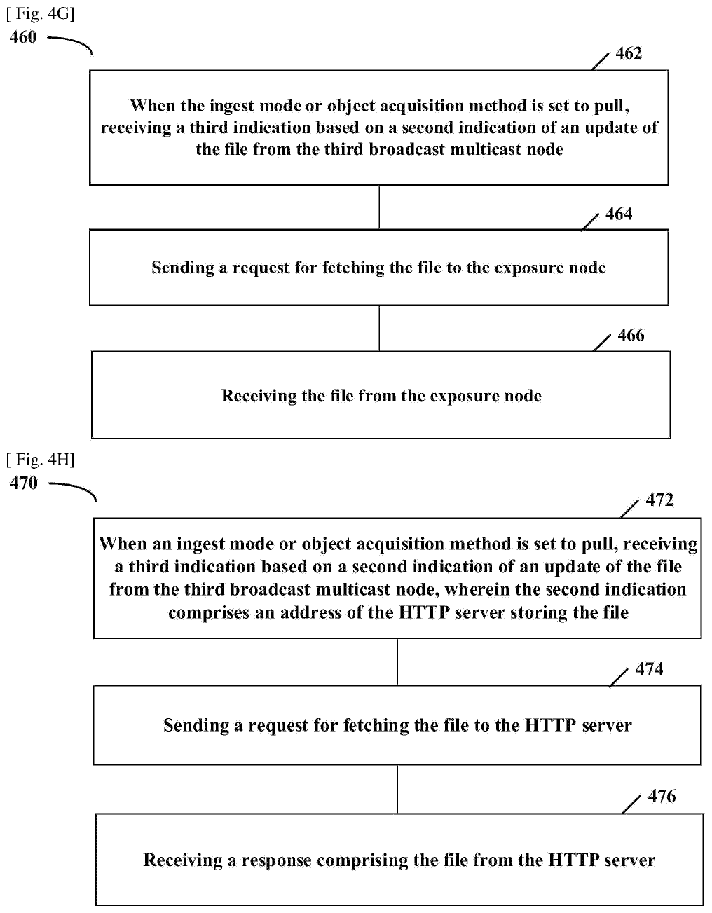

FIG. 4A shows a flowchart of a method according to another embodiment of the present disclosure, which may be performed by an apparatus implemented in/as or communicatively coupled to a second broadcast multicast node. As such, the apparatus may provide means for accomplishing various parts of the method 400 as well as means for accomplishing other processes in conjunction with other components. For some parts which have been described in the above embodiments, the description thereof is omitted here for brevity.

At block 402, the second broadcast multicast node may receive a file from an exposure node or receive an HTTP DELETE for canceling file delivery from the exposure node or receive a first indication of a cancel of file delivery from a third broadcast multicast node. The file may be transformed from a group message payload and the group message payload may be comprised in a group message request indicating a modification or cancellation of group message delivery from an application node to the exposure node.

In an embodiment, the second broadcast multicast node may receive a file from an exposure node or an HTTP server or receiving an HTTP DELETE for canceling file delivery from an exposure node or receive a group message payload or a first indication of a cancel of file delivery from a third broadcast multicast node. The file is transformed from the group message payload and the group message payload is comprised in a group message request indicating a modification or cancellation of group message delivery from an application node to the exposure node.

In an embodiment, determined file meta data (e.g. in a group message delivery procedure) is used as meta data information of the file.

In an embodiment, the determined file meta data comprises a file uniform resource locator (URL) and/or a file uniform resource identifier (URI).

At block 404, optionally, when receiving the file and a group message delivery hasn't started, the second broadcast multicast node may encode the file and use the file to replace an original file. The file will be delivered after the group message delivery starts.

FIG. 4B shows a flowchart of a method according to another embodiment of the present disclosure, which may be performed by an apparatus implemented in/as or communicatively coupled to a second broadcast multicast node. As such, the apparatus may provide means for accomplishing various parts of the method 410 as well as means for accomplishing other processes in conjunction with other components. For some parts which have been described in the above embodiments, the description thereof is omitted here for brevity.

At block 412, the second broadcast multicast node may receive a file from an exposure node or receiving an HTTP DELETE for canceling file delivery from the exposure node or receiving a first indication of a cancel of file delivery from a third broadcast multicast node. The file is transformed from a group message payload and the group message payload is comprised in a group message request indicating a modification or cancellation of group message delivery from an application node to the exposure node.

In an embodiment, the second broadcast multicast node may receive a file from an exposure node or an HTTP server or receiving an HTTP DELETE for canceling file delivery from an exposure node or receive a group message payload or a first indication of a cancel of file delivery from a third broadcast multicast node. The file is transformed from the group message payload and the group message payload is comprised in a group message request indicating a modification or cancellation of group message delivery from an application node to the exposure node.

At block 414, when receiving the file and the group message delivery has started, the second broadcast multicast node may encode the file, stop on-going group message delivery and start a delivery of the file or start the delivery of the file after the on-going group message is delivered.

FIG. 4C shows a flowchart of a method according to another embodiment of the present disclosure, which may be performed by an apparatus implemented in/as or communicatively coupled to a second broadcast multicast node. As such, the apparatus may provide means for accomplishing various parts of the method 420 as well as means for accomplishing other processes in conjunction with other components. For some parts which have been described in the above embodiments, the description thereof is omitted here for brevity.

At block 422, the second broadcast multicast node may receive a file from an exposure node or an HTTP server or receiving an HTTP DELETE for canceling file delivery from an exposure node or receive a group message payload or a first indication of a cancel of file delivery from a third broadcast multicast node. The file is transformed from the group message payload and the group message payload is comprised in a group message request indicating a modification or cancellation of group message delivery from an application node to the exposure node.

At block 424, when receiving the group message payload and a group message delivery hasn't started, the second broadcast multicast node may transform the group message payload into the file, encode the file, and use the file to replace an original file. The file will be delivered after the group message delivery starts.

FIG. 4D shows a flowchart of a method according to another embodiment of the present disclosure, which may be performed by an apparatus implemented in/as or communicatively coupled to a second broadcast multicast node. As such, the apparatus may provide means for accomplishing various parts of the method 430 as well as means for accomplishing other processes in conjunction with other components. For some parts which have been described in the above embodiments, the description thereof is omitted here for brevity.

At block 432, the second broadcast multicast node may receive a file from an exposure node or an HTTP server or receiving an HTTP DELETE for canceling file delivery from an exposure node or receive a group message payload or a first indication of a cancel of file delivery from a third broadcast multicast node. The file is transformed from the group message payload and the group message payload is comprised in a group message request indicating a modification or cancellation of group message delivery from an application node to the exposure node.

At block 434, when receiving the group message payload and the group message delivery has started, the second broadcast multicast node may transform the group message payload into the file, encode the file, stop on-going group message delivery and start a delivery of the file, or start the delivery of the file after the on-going group message is delivered.

FIG. 4E shows a flowchart of a method according to another embodiment of the present disclosure, which may be performed by an apparatus implemented in/as or communicatively coupled to a second broadcast multicast node. As such, the apparatus may provide means for accomplishing various parts of the method 440 as well as means for accomplishing other processes in conjunction with other components. For some parts which have been described in the above embodiments, the description thereof is omitted here for brevity.

At block 442, the second broadcast multicast node may receive a file from an exposure node or receiving an HTTP DELETE for canceling file delivery from the exposure node or receiving a first indication of a cancel of file delivery from a third broadcast multicast node. The file is transformed from a group message payload and the group message payload is comprised in a group message request indicating a modification or cancellation of group message delivery from an application node to the exposure node.

In an embodiment, the second broadcast multicast node may receive a file from an exposure node or an HTTP server or receiving an HTTP DELETE for canceling file delivery from an exposure node or receive a group message payload or a first indication of a cancel of file delivery from a third broadcast multicast node. The file is transformed from the group message payload and the group message payload is comprised in a group message request indicating a modification or cancellation of group message delivery from an application node to the exposure node.

At block 444, when receiving the first indication or the HTTP DELETE and the group message delivery has started, the second broadcast multicast node may stop file delivery and/or inform a multicast/broadcast service (MBS) client a cancellation of file delivery.

In an embodiment, the cancellation is delivered in-band of an MBS session or out-band of the MBS session to at least one MBS client.

FIG. 4F shows a flowchart of a method according to another embodiment of the present disclosure, which may be performed by an apparatus implemented in/as or communicatively coupled to a second broadcast multicast node. As such, the apparatus may provide means for accomplishing various parts of the method 450 as well as means for accomplishing other processes in conjunction with other components. For some parts which have been described in the above embodiments, the description thereof is omitted here for brevity.

At block 452, the second broadcast multicast node may receive a file from an exposure node or receiving an HTTP DELETE for canceling file delivery from the exposure node or receiving a first indication of a cancel of file delivery from a third broadcast multicast node. The file is transformed from a group message payload and the group message payload is comprised in a group message request indicating a modification or cancellation of group message delivery from an application node to the exposure node.

In an embodiment, the second broadcast multicast node may receive a file from an exposure node or an HTTP server or receiving an HTTP DELETE for canceling file delivery from an exposure node or receive a group message payload or a first indication of a cancel of file delivery from a third broadcast multicast node. The file is transformed from the group message payload and the group message payload is comprised in a group message request indicating a modification or cancellation of group message delivery from an application node to the exposure node.

At block 454, when receiving the first indication or the HTTP DELETE and a group message delivery hasn't started, the second broadcast multicast node may cancel file delivery and/or inform a multicast/broadcast service (MBS) client a cancellation of file delivery.

In an embodiment, the cancellation is delivered in-band of an MBS session or out-band of the MBS session to at least one MBS client.

FIG. 4G shows a flowchart of a method according to another embodiment of the present disclosure, which may be performed by an apparatus implemented in/as or communicatively coupled to a second broadcast multicast node. As such, the apparatus may provide means for accomplishing various parts of the method 460 as well as means for accomplishing other processes in conjunction with other components. For some parts which have been described in the above embodiments, the description thereof is omitted here for brevity.

In an embodiment, when the ingest mode or object acquisition method is set to pull, the second broadcast multicast node may receive the file from the exposure node as follows.

At block 462, the second broadcast multicast node may receive a third indication based on a second indication of an update of the file from the third broadcast multicast node.

At block 464, the second broadcast multicast node may send a request for fetching the file to the exposure node.

At block 466, the second broadcast multicast node may receive the file from the exposure node.

FIG. 4H shows a flowchart of a method according to another embodiment of the present disclosure, which may be performed by an apparatus implemented in/as or communicatively coupled to a second broadcast multicast node. As such, the apparatus may provide means for accomplishing various parts of the method 470 as well as means for accomplishing other processes in conjunction with other components. For some parts which have been described in the above embodiments, the description thereof is omitted here for brevity.

In an embodiment, when an ingest mode or object acquisition method is set to pull, the second broadcast multicast node may receive the file from the HTTP server as follows.

At block 472, the second broadcast multicast node may receive a third indication based on a second indication of an update of the file from the third broadcast multicast node. The second indication comprises an address of the HTTP server storing the file.

At block 474, the second broadcast multicast node may send a request for fetching the file to the HTTP server.

At block 476, the second broadcast multicast node may receive a response comprising the file from the HTTP server.

In an embodiment, the second indication is a property or a parameter with a refresh or update value within multicast/broadcast service (MBS) distribution session parameter to inform the second broadcast multicast node about the refresh of the file.

FIG. 4I shows a flowchart of a method according to another embodiment of the present disclosure, which may be performed by an apparatus implemented in/as or communicatively coupled to a second broadcast multicast node. As such, the apparatus may provide means for accomplishing various parts of the method 480 as well as means for accomplishing other processes in conjunction with other components. For some parts which have been described in the above embodiments, the description thereof is omitted here for brevity.

In an embodiment, when the ingest mode or object acquisition method is set to push, the second broadcast multicast node may receive the file from the exposure node as follows.

At block 482, the second broadcast multicast node may receive the file pushed by the exposure node.

In an embodiment, the file is included in a file list.

In an embodiment, the first indication is a property or a parameter with a cancel value (e.g. within MBS distribution session parameter) to inform the second broadcast multicast node about cancel of file delivery.

In an embodiment, the exposure node comprises a NEF or a combined NEF and SCEF.

In an embodiment, the second broadcast multicast node comprises an MBSTF.

In an embodiment, the third broadcast multicast node comprises an MBSF.

In an embodiment, the group message request comprises a modify group message request with a requested action set to modify or cancel.

In an embodiment, the group message request comprises a modify group message request or a cancel group message request.

FIG. 5 shows a flowchart of a method according to another embodiment of the present disclosure, which may be performed by an apparatus implemented in/as or communicatively coupled to a third broadcast multicast node. As such, the apparatus may provide means for accomplishing various parts of the method 500 as well as means for accomplishing other processes in conjunction with other components. For some parts which have been described in the above embodiments, the description thereof is omitted here for brevity.

At block 502, the third broadcast multicast node may receive a second indication of an update of a file or a first indication of a cancel of file delivery from an exposure node. The file may be transformed from the group message payload and the group message payload may be comprised in a group message request indicating a modification or cancellation of group message delivery from an application node to the exposure node.

In an embodiment, the third broadcast multicast node may receive a second indication of an update of a file or a group message payload or a first indication of a cancel of file delivery from an exposure node The file is transformed from the group message payload and the group message payload is comprised in a group message request indicating a modification or cancellation of group message delivery from an application node to the exposure node.

At block 504, the third broadcast multicast node may send the second indication or the first indication to a second broadcast multicast node.

In an embodiment, the third broadcast multicast node may send the second indication or the group message payload or the first indication to a second broadcast multicast node.

At block 506, optionally, when receiving the first indication, the third broadcast multicast node may inform a multicast/broadcast service (MBS) client a cancellation of file delivery.

In an embodiment, the cancellation is delivered in-band of an MBS session or out-band of the MBS session to at least one MBS client.

In an embodiment, the third broadcast multicast node may inform a multicast/broadcast service (MBS) client a cancellation of file delivery.

In an embodiment, the first indication is a property or a parameter with a cancel value (e.g. within session parameters) to inform the second broadcast multicast node about cancel of file delivery.

In an embodiment, the second indication is a property or a parameter with a refresh or update value within session parameters to inform the second broadcast multicast node about the refresh of the file.

In an embodiment, the exposure node comprises a NEF or a combined NEF and SCEF.

In an embodiment, the second broadcast multicast node comprises an MBSTF.

In an embodiment, the third broadcast multicast node comprises an MBSF.

In an embodiment, the group message request comprises a modify group message request with a requested action set to modify or cancel.

In an embodiment, the group message request comprises a modify group message request or a cancel group message request.

FIG. 6A shows a flowchart of a method according to another embodiment of the present disclosure, which may be performed by an apparatus implemented in/as or communicatively coupled to a user equipment. As such, the apparatus may provide means for accomplishing various parts of the method 600 as well as means for accomplishing other processes in conjunction with other components. For some parts which have been described in the above embodiments, the description thereof is omitted here for brevity.

At block 602, the user equipment may receive a message from a second broadcast multicast node or a third broadcast multicast node. The message comprises a cancellation of file delivery.

In an embodiment, the user equipment may receive a message from a first broadcast multicast node. The message comprises a cancellation of file delivery.

For example, as described above, the first/second/third broadcast multicast node may inform an MBS/MBMS client of the user equipment a cancellation of file delivery and then the user equipment may receive the message from the first broadcast multicast node or the second broadcast multicast node or the third broadcast multicast node.

In an embodiment, the cancellation is received in-band of a multicast/broadcast service (MBS) session or Multimedia Broadcast/Multicast Service (MBMS) session or out-band of the MBS session or MBMS session.

In an embodiment, the user equipment comprises a multicast/broadcast service (MBS) client or a Multimedia Broadcast/Multicast Service (MBMS) client.

In an embodiment, the first broadcast multicast node comprises at least one of a Broadcast Multicast Service Centre (BM-SC), or a combined BM-SC, Multicast/Broadcast Service Function (MBSF) and Multicast/Broadcast Service Transport Function (MBSTF).

In an embodiment, the second broadcast multicast node comprises an MBSTF, and the third broadcast multicast node comprises an MBSF.

FIG. 6B shows a flowchart of Group Message Delivery over MBMS in EPS according to another embodiment of the present disclosure.

At step 1. The AF sends Modify Group Message Request to the SCEF, containing the Request Action, Group Message Payload, location information, Group Message Delivery Start Time, Stop Time, External Group Identifier. The SCEF identifies the associated MBS Service using the external Group Identifier. Requested Action is either set to “Modify”, or “Cancel”. “Modify” indicates the request is to modify the group message delivery transaction. “Cancel” indicates the request is to cancel the group message delivery transaction.

There may be any other parameters in Modify Group Message Request.

At step 2. The SCEF checks authorization of AF. The SCEF translates location information to either a list of MBMS Service Area Identities, or a list of cell IDs, or both as the MBMS broadcast area.

If Requested Action is “Modify” and Group Message Payload is updated, step 3 to step 5 are executed:

At step 3. The SCEF transforms the group message payload into a file, and uses the determined file meta data (e.g. File URL, or File URI etc.) in group message delivery procedure.

At step 4. If Ingest Mode is Pull, the SCEF invokes Update Session towards BM-SC, which indicating an update of the file. The indication may be a property or a parameter with the refresh or update value within the Session parameters to inform the BM-SC about the refresh of the file. The file can also be included in a file list.

At step 5. If Ingest Mode is Pull, the BM-SC pulls the file from SCEF. If Ingest Mode is Push, the SCEF pushes the updated file to BM-SC.

At step 6. The BM-SC performs packetization and optionally FEC encoding for the updated file.

If the group message deliver hasn't started, the BM-SC simply uses the updated file to replace the original one. And the updated file will be delivered after the delivery starts.

If the group message delivery started, the BM-SC stops the on-going delivery, and starts the delivery of the updated file towards the MBMS GW (gateway). MBMS-GW delivers the content to the LTE-RANs and the LTE-RANs broadcast the content towards the UEs.

If Requested Action is “Modify” and MBS service area is updated, step 7 to step 8 are executed.

At step 7. The SCEF invokes Update Session on the BM-SC. The update service operation indicates MBMS service area update.

At step 8. The BM-SC performs MBMS Session Update procedure to update MBMS service area

If Requested Action is “Cancel”, step 9 to step 13 are executed. If the group message delivery hasn't started, step 9 to step 11 can be skipped. If the group message delivery has started, step 9 to step 11 are needed when BM-SC needs to inform the MBMS Client about the cancellation of the file delivery.

At step 9. If Ingest Mode is set to Pull, the SCEF invokes Update Session on the BM-SC. The update service operation indicates the cancel of the file delivery. The indication may be a property or a parameter with a cancel value (e.g., within the Session parameter) to inform the BM-SC about the cancellation of the file. The file can also be included in a file list.

At step 10. If Ingest Mode is set to Push, the SCEF sends HTTP DELETE to the BM-SC to cancel the file delivery.

At step 11. The BM-SC stops the file delivery and informs the MBMS Client the cancellation if needed. The cancellation can be included in the Schedule Fragment which is delivered in-band of the MBMS session or out-band of the MBMS.

At step 12. The SCEF invokes Terminate Session on the BM-SC.

At step 13. The BM-SC triggers to perform MBMS Session Stop towards LTE RANS via EPC.

At step 14. The SCEF sends Modify Group Message Response to the AF.

FIG. 6C shows a flowchart of another option of step 3 to step 5 of FIG. 6B according to another embodiment of the present disclosure.

At step a. The SCEF sends the group message modify request with updated group message to the BM-SC. The BM-SC responds the SCEF.

At step b. The BM-SC transforms the updated group message into a file.

FIG. 6D shows a flowchart of Group Message Modification and Cancellation over MBS broadcast according to another embodiment of the present disclosure.

In the procedures referred to the 3GPP TS 26.502 v1.0.0, the NEF is the MBS Application Provider.

At step 1. The AF sends Modify Group Message Request to the NEF, containing the Request Action, Group Message Payload, MBS service area, Group Message Delivery Start Time, Stop Time, External Group Identifier. The NEF identifies the associated MBS Service using the external Group Identifier. Requested Action is either set to “Modify”, or “Cancel”. “Modify” indicates the request is to modify the group message delivery transaction. “Cancel” indicates the request is to cancel the group message delivery transaction.

There may be any other parameters in Group Message Request.

At step 2. The NEF checks authorization of AF. If geographical area information or civic address information was provided by the AF as MBS service area, the NEF translates the MBS service area to Cell ID list or TAI list.

If Requested Action is “Modify” and Group Message Payload is updated, step 3 to step 6 are executed:

At step 3. The NEF transforms the group message payload into a file, and uses the determined file meta data (e.g. File URL, File URI, etc.).

At step 4. If Object acquisition method is set to Push, step 4 to step 5 can be skipped. If Object acquisition method is set to Pull, the NEF invokes Update MBS User Data Ingest Session (Nmbsf_MBSUserDataIngestSession_Update) on the MBSF. The update service operation indicates an update of the file containing the updated group message. The indication may be a property or parameter with the refresh or update value within the MBS Distribution Session parameter to inform the MBSF about the refresh of the file. The file can also be included in a file list.

At step 5. The MBSF invokes Update MBS Distribution Session (Nmbstf_MBSDistributionSession_Update) on the MBSTF. The update service operation indicates an update of the file containing the updated group message. The indication may be a property or parameter with the refresh or update value within the MBS Distribution Session parameter to inform the MBSF about the refresh of the file. The file can also be included in a file list.

At step 6. If Object acquisition method is set to Push, the NEF pushes the update file to the MBSTF. If Object acquisition method is set to Pull, the MBSTF pulls the updated file from the NEF.

At step 7. The MBSTF performs packetization and optionally FEC encoding for the updated file.

If the group message deliver hasn't started, the MBSTF simply uses the updated file to replace the original one. And the updated file will be delivered after the delivery starts.

If the group message delivery started, the MBSTF stops the on-going delivery, and starts the delivery of the updated file towards the MB-UPF. MB-UPF delivers the content to the NG-RANs and the NG-RANs broadcast the content towards the UEs.

If Requested Action is “Modify” and MBS service area is updated, step 8 to step 9 are executed:

At step 8. The NEF the NEF invokes Nmbsf_MBSUserService_Update on the MBSF. The update service operation indicates MBS service area update.

At step 9. The MBSF performs MBS Session Update as specified in clause 7.1.1.6 or clause 7.1.1.7 of 3GPP TS 23.247 V17.2.0 to update MBS service area, which triggers MBS Session Update for Broadcast as specified in clause 7.3.3 of 3GPP TS 23.247 V17.2.0.

If Requested Action is “Cancel”, step 10 to step 16 are executed. If the group message delivery hasn't started, step 10 to step 13 can be skipped. If the group message delivery has started, step 10 to step 13 are needed when MBSF needs to inform the MBS Client about the cancellation of the file delivery.

At step 10. If Object acquisition method is set to Push, step 10 to step 11 can be skipped. If Object acquisition method is set to Pull, the NEF invokes Update MBS User Data Ingest Session (Nmbsf_MBSUserDataIngestSession_Update) on the MBSF. The update service operation indicates the cancel of the file delivery. The indication may be a property or parameter with a cancel value within the MBS Distribution Session parameter to inform the MBSF about the cancellation of the file. The file can also be included in a file list.

At step 11. The MBSF invokes Update MBS Distribution Session (Nmbstf_MBSDistributionSession_Update) on the MBSTF. The update service operation indicates the cancel of the file delivery. The indication may be a property with a cancel value within the MBS Distribution Session parameter to inform the MBSF about the cancellation of the file. The file can also be included in a file list. The MBSTF stops the file delivery.

At step 12. If Object acquisition method is set to Push, the NEF may send HTTP DELETE to the MBSTF to cancel the file delivery. The MBSTF stops the file delivery.

At step 13. The MBSF informs the MBS Client about the cancel of the file delivery if needed, which can be in-band delivered within the MBS broadcast session to the MBS Client or out-band.

At step 14. The NEF invokes Destroy MBS User Data Ingest Session (Nmbsf_MBSUserDataIngestSession_Destroy) or Delete MBS User Data Ingest Session (Nmbsf_MBSUserDataIngestSession_DELETE) on the MBSF.

At step 15. The MBSF invokes Destroy MBS Distribution Session (Nmbstf_MBSDistributionSession_Destroy) or Delete MBS User Distribution Session (Nmbstf_MBSDistributionSession_DELETE) on the MBSTF.

At step 16. The MBSF performs MBS Session Deletion as specified in clause 7.1.1.4 or clause 7.1.1.5 of 3GPP TS 23.247 V17.2.0, which triggers MBS Session Release for Broadcast as specified in clause 7.3.2 of 3GPP TS 23.247 V17.2.0.

At step 17. The NEF sends Modify Group Message Response to the AF.

FIG. 6E shows a flowchart of another option of step 3 to step 6 of FIG. 6D according to another embodiment of the present disclosure.

At step a. The NEF sends the group message modify request with updated group message to the MBSF. The MBSF responds the NEF.

At step b. The MBSF sends the group message modify request with the updated to the MBSTF. The MBSTF responds the MBSF.

At step c. The MBSTF transforms the updated group message into a file.

FIG. 6F shows a flowchart of Group Message Delivery over MBMS and MBS broadcast according to another embodiment of the present disclosure.

The flowchart of FIG. 6F is same as the flowchart of FIG. 6B, except the following additions.

SCEF is replaced by SCEF+NEF.

BM-SC is replaced by BM-SC+MBSF+MBSTF.

At step 4, if Ingest Mode is Pull, the SCEF+NEF invokes Update Session and/or Update MBS User Data Ingest Session towards BM-SC+MBSF+MBSTF, which indicating an update of the file.

At step 6, BM-SC+MBSF+MBSTF delivers content to LTE-RAN via EPC and NG-RAN via 5GC separately.

At step 7, the SCEF+NEF invokes Update Session and/or Update MBS User Service towards BM-SC+MBSF+MBSTF. The update service operation indicates MBMS service area update.

At step 8, BM-SC+MBSF+MBSTF performs MBMS Session Update procedure to update MBMS service area in eMBMS and performs MBS Session Update procedure to update MBS service area in MBS separately.

At step 9, the SCEF+NEF invokes Update Session and/or Update MBS User Service towards BM-SC+MBSF+MBSTF. The update service operation indicates a cancellation of the file.

At step 11, BM-SC+MBSF+MBSTF informs the cancellation towards MBMS Client and MBS Client separately. The cancellation can be in-band delivered in the MBMS session and MBS broadcast session, or out-band.

At step 12, BM-SC+MBSF+MBSTF performs MBMS Session Stop procedures in eMBMS and performs MBS Session Deletion procedure in MBS separately.

FIG. 6G shows a flowchart of another option of step 3 to step 5 of FIG. 6F according to another embodiment of the present disclosure.

At step a. The SCEF+NEF sends the group message modify request with updated group message to the BM-SC+MBSF+MBSTF. The BM-SC+MBSF+MBSTF responds the SCEF+NEF.

At step b. The BM-SC+MBSF+MBSTF transforms the updated group message into a file.

In an embodiment, the following content may be added into 3GPP TR 23.700-47 V0.2.0.

It is proposed to capture the following changes in3GPP TR 23.700-47 V0.2.0.

FIG. 7 shows a flowchart of Modify or Cancel Group Message Delivery via an MBS Broadcast according to another embodiment of the present disclosure.

In the procedures referred to the 3GPP TS 26.502 v1.0.0, the NEF is the MBS Application Provider.

At step 1. The AF sends Modify Group Message Request to the NEF, containing the Request Action, Group Message Payload, MBS service area, Group Message Delivery Start Time, Stop Time, External Group Identifier. The NEF identifies the associated MBS Service using the external Group Identifier. Requested Action is either set to “Modify”, or “Cancel”. “Modify” indicates the request is to modify the group message delivery transaction. “Cancel” indicates the request is to cancel the group message delivery transaction.

The other parameters in Group Message Request is FFS.

At step 2. The NEF checks authorization of AF. If geographical area information or civic address information was provided by the AF as MBS service area, the NEF translates the MBS service area to Cell ID list or TAI list.

If Requested Action is “Modify” and Group Message Payload is updated, step 3 to step 6 are executed:

At step 3. The NEF transforms the group message payload into a file, and use the determined file meta data (e.g. File URL, etc.) in clause 6.12.3.2 of 3GPP TR 23.700-47 V0.2.0.

At step 4. If Object acquisition method is set to Push, step 4 to step 5 can be skipped. If Object acquisition method is set to Pull, the NEF invokes Nmbsf_MBSUserDataIngestSession_Update on the MBSF. The update service operation indicates an update of the file containing the updated group message.

At step 5. The MBSF invokes Nmbstf_MBSDistributionSession_Update on the MBSTF. The update service operation indicates an update of the file containing the updated group message.

At step 6. If Object acquisition method is set to Push, the NEF pushes the update file to the MBSTF. If Object acquisition method is set to Pull, the MBSTF pull the updated file from the NEF. And the MBSTF delivers the updated file towards the MB-UPF in 5GC.

If Requested Action is “Modify” and MBS service area is updated, step 7 to step 8 are executed:

At step 7. The NEF invokes Nmbsf_MBSUserService_Update on the MBSF. The update service operation indicates MBS service area update.

At step 8. The MBSF performs MBS Session Update as specified in clause 7.1.1.6 or clause 7.1.1.7 of 3GPP TS 23.247 V17.2.0 to update MBS service area, which triggers MBS Session Update for Broadcast as specified in clause 7.3.3 of 3GPP TS 23.247 V17.2.0.

If Requested Action is “Cancel”, step 9 to step 14 are executed: step 9 to step 11 are needed when the group message delivery has started and MBSF needs to inform the MBS Client about the cancel of the file delivery. Otherwise, they can be skipped.

At step 9. The NEF invokes Nmbsf_MBSUserDataIngestSession_Update on the MBSF. The update service operation indicates the cancel of the file delivery. The MBSF informs the MBS Client about the cancel of the file delivery if needed.

At step 10. If Object acquisition method is set to Pull, the MBSF invokes Nmbstf_MBSDistributionSession_Update on the MBSTF. The update service operation indicates the cancel of the file delivery. The MBSTF stops the file delivery.

At step 11. If Object acquisition method is set to Push, the NEF may send HTTP DELETE to the MBSTF to cancel the file delivery. The MBSTF stops the file delivery.

At step 12. The NEF invokes Nmbsf_MBSUserDataIngestSession_Destroy on the MBSF.

At step 13. The MBSF invokes Nmbstf_MBSDistributionSession_Destroy on the MBSTF.

At step 14. The MBSF performs MBS Session Deletion as specified in clause 7.1.1.4 or clause 7.1.1.5 of 3GPP TS 23.247 V17.2.0., which triggers MBS Session Release for Broadcast as specified in clause 7.3.2 of 3GPP TS 23.247 V17.2.0.

At step 15. The NEF sends Modify Group Message Response to the AF.

In an embodiment, the following content may be added into 3GPP TR 23.700-47 V0.2.0.

### 6. X. 4 Impacts on Services, Entities and Interfaces.

Functional entities defined in clause 5.3.2 of 3GPP TS 23.247 V17.2.0 and clause 6.2 of 3GPP TS 23.501 V17.1.1 are reused exception for the following additions:

NEF:
Support group message delivery and modify group message interfaces towards AF, and optionally include the service announcement information in the group message delivery response to the AF
Transform the group message into a file and determine the meta data information of the file.
Create MBS User Service and MBS User Data Ingest Session to the MBSF in group message delivery
Update MBS User Service to the MBSF for MBS service area update. Update MBS User Data Ingest Session to the MBSF when the group message is updated.
Optionally update MBS User Data Ingest Session to the MBSF to cancel the file or DELETE the file to the MBSTF, when the group message delivery has started and MBSF needs to inform the MBSF Client about the cancel of the file delivery. Destroy MBS User Data Ingest Session to the MBSF
   Ingest file to the MBSTF

Many advantages may be achieved by applying the proposed solution according to embodiments of the present disclosure. For example, some embodiments herein may enable the group message modification and group message cancellation over MBMS, MBS and MBS with interworking with MBMS. Some embodiments herein may fix the drawbacks within the current group message modification via MBMS (it is not workable to replace the group message using Update Session Properties to BM-SC). Some embodiments herein may improve the limitation with the current group message cancellation via MBMS (SCEF Terminate Session towards BM-SC but UE is not aware of the cancellation of the group message). The embodiments herein are not limited to the features and advantages mentioned above. A person skilled in the art will recognize additional features and advantages upon reading the following detailed description.

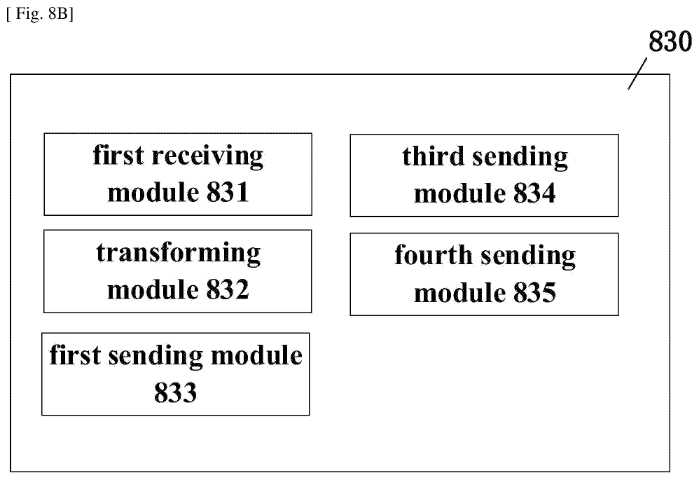

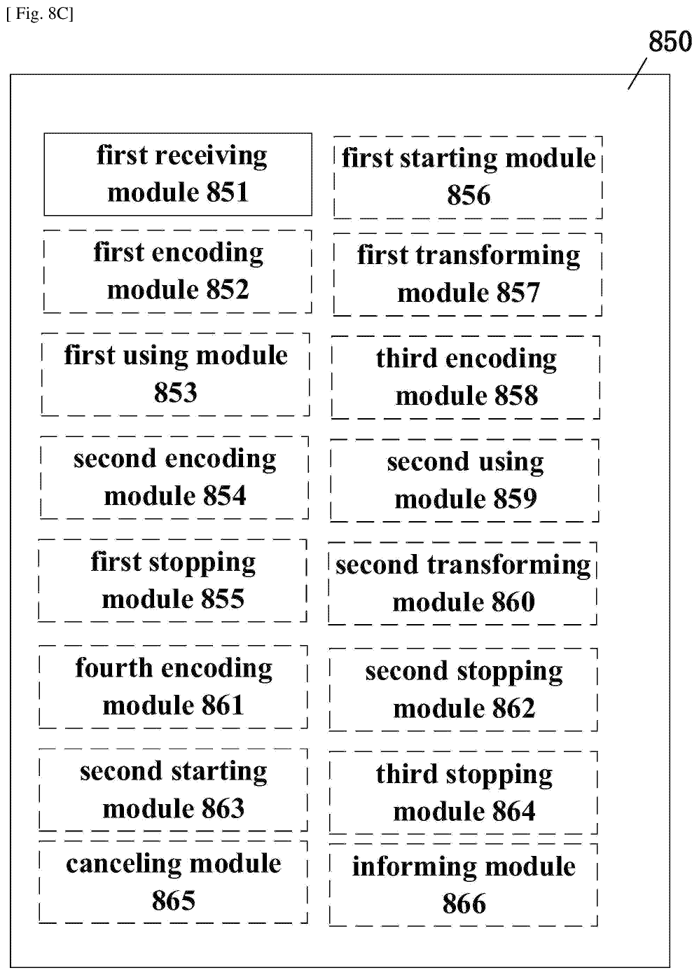

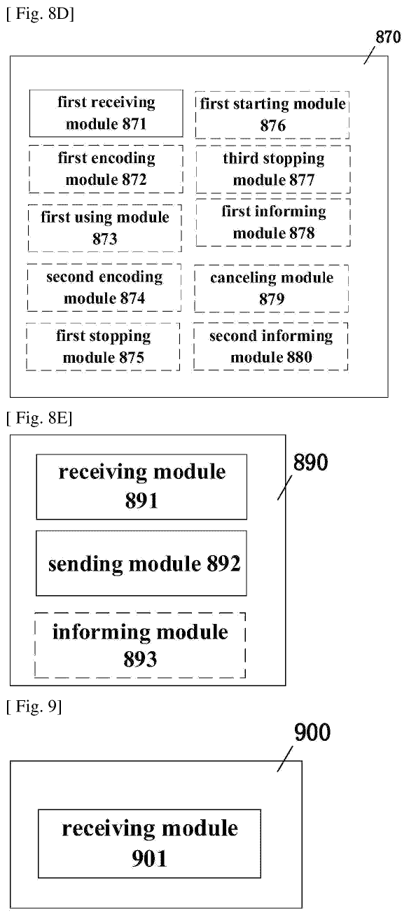

FIG. 8A is a block diagram showing an apparatus suitable for practicing some embodiments of the disclosure. For example, the exposure node, the first broadcast multicast node, the second broadcast multicast node, the third broadcast multicast node, and the user equipment described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the exposure node, the memory 822 contains instructions executable by the processor 821, whereby the exposure node operates according to any of the methods related to the exposure node as described above.

In an embodiment where the apparatus is implemented as or at the first broadcast multicast node, the memory 822 contains instructions executable by the processor 821, whereby the first broadcast multicast node operates according to any of the methods related to the first broadcast multicast node as described above.

In an embodiment where the apparatus is implemented as or at the second broadcast multicast node, the memory 822 contains instructions executable by the processor 821, whereby the second broadcast multicast node operates according to any of the methods related to the second broadcast multicast node as described above.

In an embodiment where the apparatus is implemented as or at the third broadcast multicast node, the memory 822 contains instructions executable by the processor 821, whereby the third broadcast multicast node operates according to any of the methods related to the third broadcast multicast node as described above.

In an embodiment where the apparatus is implemented as or at the user equipment, the memory 822 contains instructions executable by the processor 821, whereby the user equipment operates according to any of the methods related to the user equipment as described above.

FIG. 8B is a block diagram showing an exposure node according to an embodiment of the disclosure. As shown, the exposure node 830 comprises a first receiving module 831 configured to receive a group message request from an application node.

In an embodiment, when the group message request is for a modification of group message delivery and comprises group message payload, the exposure node 830 further comprises a transforming module 832 configured to transform the group message payload into a file. The exposure node 830 further comprises a first sending module 833 configured to send the file to a second broadcast multicast node.

In an embodiment, when the group message request is for a cancellation of group message delivery, the exposure node 830 further comprises a third sending module 834 configured to send a first indication of a cancel of a file delivery to the third broadcast multicast node. The exposure node 830 further comprises a fourth sending module 835 configured to send an HTTP DELETE to the second broadcast multicast node to cancel file delivery.

FIG. 8C is a block diagram showing a first broadcast multicast node according to an embodiment of the disclosure. As shown, the first broadcast multicast node 850 comprises a first receiving module 851 configured to receive a file from an exposure node or an HTTP server or receiving a group message payload or a first indication of a cancel of file delivery or an HTTP DELETE for canceling file delivery from an exposure node. The file is transformed from the group message payload and the group message payload is comprised in a group message request indicating a modification or cancellation of group message delivery from an application node to the exposure node.

In an embodiment, when receiving the file and a group message delivery hasn't started, the first broadcast multicast node 850 further comprises a first encoding module 852 configured to encode the file and a first using module 853 configured to use the file to replace an original file. The file will be delivered after the group message delivery starts.

In an embodiment, when receiving the file and the group message delivery has started, the first broadcast multicast node 850 further comprises a second encoding module 854 configured to encode the file, a first stopping module 855 configured to stop on-going group message delivery, a first starting module 856 configured to start a delivery of the file or start the delivery of the file after the on-going group message is delivered.

In an embodiment, when receiving the group message payload and a group message delivery hasn't started, the first broadcast multicast node 850 further comprises a first transforming module 857 configured to transform the group message payload into the file, a third encoding module 858 configured to encode the file, and a second using module 859 configured to use the file to replace an original file. The file will be delivered after the group message delivery starts.

In an embodiment, when receiving the group message payload and the group message delivery has started, the first broadcast multicast node 850 further comprises a second transforming module 860 configured to transform the group message payload into the file, a fourth encoding module 861 configured to encode the file, a second stopping module 862 configured to stop on-going group message delivery and a second starting module 863 configured to start a delivery of the file or start the delivery of the file after the on-going group message is delivered.

In an embodiment, when receiving the first indication or the HTTP DELETE and the group message delivery has started, the first broadcast multicast node 850 further comprises a third stopping module 864 configured to stop file delivery and/or informing a Multimedia Broadcast/Multicast Service (MBMS) client a cancellation of file delivery.

In an embodiment, when receiving the first indication or the HTTP DELETE and a group message delivery hasn't started, the first broadcast multicast node 850 further comprises a canceling module 865 configured to cancel file delivery and/or an informing module 866 configured to inform a Multimedia Broadcast/Multicast Service (MBMS) client a cancellation of file delivery.

FIG. 8D is a block diagram showing a second broadcast multicast node according to an embodiment of the disclosure. As shown, the second broadcast multicast node 870 comprises a first receiving module 871 configured to receive a file from an exposure node or receive an HTTP DELETE for canceling file delivery from the exposure node or receive a first indication of a cancel of file delivery from a third broadcast multicast node. The file may be transformed from a group message payload and the group message payload may be comprised in a group message request indicating a modification or cancellation of group message delivery from an application node to the exposure node.

In an embodiment, when receiving the file and a group message delivery hasn't started, the second broadcast multicast node 870 further comprises a first encoding module 872 configured to encode the file and a first using module 873 configured to use the file to replace an original file. The file will be delivered after the group message delivery starts.

In an embodiment, when receiving the file and the group message delivery has started, the second broadcast multicast node 870 further comprises a second encoding module 874 configured to encode the file, a first stopping module 875 configured to stop on-going group message delivery and a first starting module 876 configured to start a delivery of the file or start the delivery of the file after the on-going group message is delivered.

In an embodiment, when receiving the first indication or the HTTP DELETE and the group message delivery has started, the second broadcast multicast node 870 further comprises a third stopping module 877 configured to stop file delivery and/or a first informing module 878 configured to inform a multicast/broadcast service (MBS) client a cancellation of file delivery.

In an embodiment, when receiving the first indication or the HTTP DELETE and a group message delivery hasn't started, the second broadcast multicast node 870 further comprises a canceling module 879 configured to cancel file delivery and/or a second informing module 880 configured to inform a multicast/broadcast service (MBS) client a cancellation of file delivery.

FIG. 8E is a block diagram showing a third broadcast multicast node according to an embodiment of the disclosure. As shown, the third broadcast multicast node 890 comprises a receiving module 891 configured to receive a second indication of an update of a file or a group message payload or a first indication of a cancel of file delivery from an exposure node. The file is transformed from the group message payload and the group message payload is comprised in a group message request indicating a modification or cancellation of group message delivery from an application node to the exposure node. The third broadcast multicast node 880 further comprises a sending module 892 configured to send the second indication or the group message payload or the first indication to a second broadcast multicast node.

In an embodiment, the third broadcast multicast node 880 further comprises an informing module 893 configured to, when receiving the first indication, inform a multicast/broadcast service (MBS) client a cancellation of file delivery.

FIG. 9 is a block diagram showing a user equipment according to an embodiment of the disclosure. As shown, the user equipment 900 comprises a receiving module 901 configured to receive a message from a second broadcast multicast node or a third broadcast multicast node. The message may comprise a cancellation of file delivery.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the exposure node, the first broadcast multicast node, the second broadcast multicast node, the third broadcast multicast node, and the user equipment may not need a fixed processor or memory, any computing resource and storage resource may be arranged from the exposure node, the first broadcast multicast node, the second broadcast multicast node, the third broadcast multicast node, and the user equipment in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Further, the exemplary overall commutation system including the terminal device above mentioned and the network node (such as the exposure node, the first broadcast multicast node, the second broadcast multicast node, or the third broadcast multicast node above mentioned) will be introduced as below.

Embodiments of the present disclosure provide a communication system including a host computer including: processing circuitry configured to provide user data; and a communication interface configured to forward the user data to a cellular network for transmission to a terminal device. The cellular network includes a base station such as radio access network node above mentioned, and/or the terminal device such as the UE above mentioned.

In embodiments of the present disclosure, the system further includes the terminal device. The terminal device is configured to communicate with the base station.

In embodiments of the present disclosure, the processing circuitry of the host computer is configured to execute a host application, thereby providing the user data; and the terminal device includes processing circuitry configured to execute a client application associated with the host application.

Embodiments of the present disclosure also provide a communication system including a host computer including: a communication interface configured to receive user data originating from a transmission from a terminal device; a base station. The transmission is from the terminal device to the base station. The terminal device is above mentioned UE. The base station is above mentioned radio access network node.

In embodiments of the present disclosure, the processing circuitry of the host computer is configured to execute a host application. The terminal device is configured to execute a client application associated with the host application, thereby providing the user data to be received by the host computer.

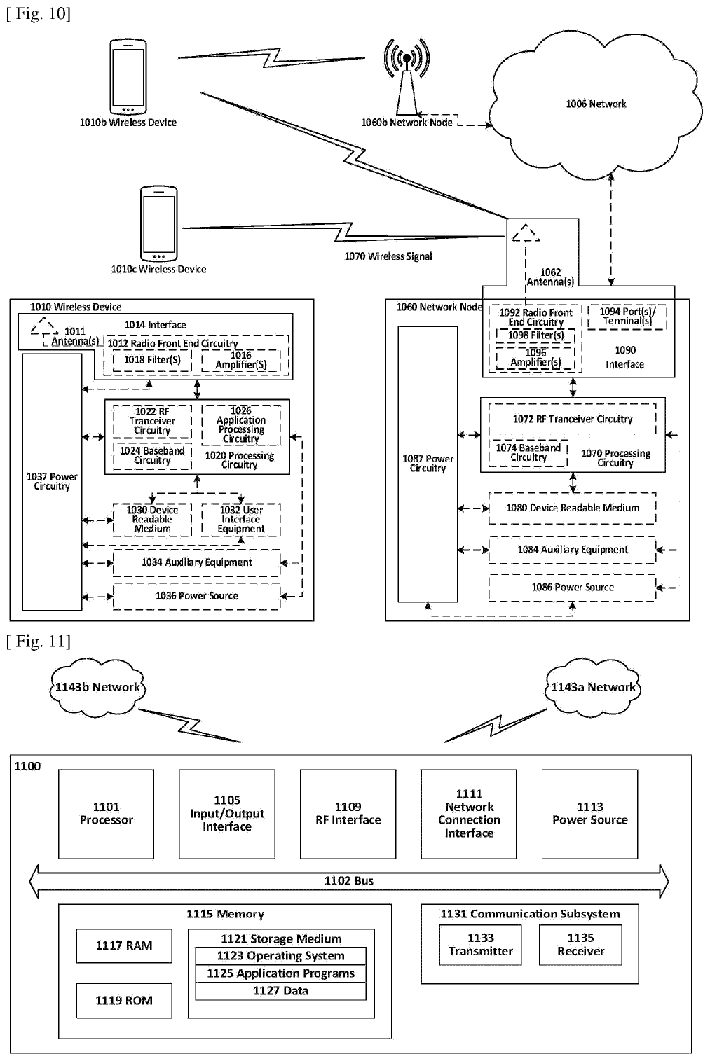

FIG. 10 is a schematic showing a wireless network in accordance with some embodiments.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 1006, network nodes 1060 (corresponding to network side node) and 1060b, and WDs (corresponding to terminal device) 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (cNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and

RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise onc or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 10 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, cither alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, onc or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

FIG. 11 is a schematic showing a user equipment in accordance with some embodiments.

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3rd Generation Partnership Project (3GPP), including a NB-IoT UE, a machine type communication (MTC) UE, and/or an enhanced MTC (eMTC) UE. UE 1100, as illustrated in FIG. 11, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 11, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

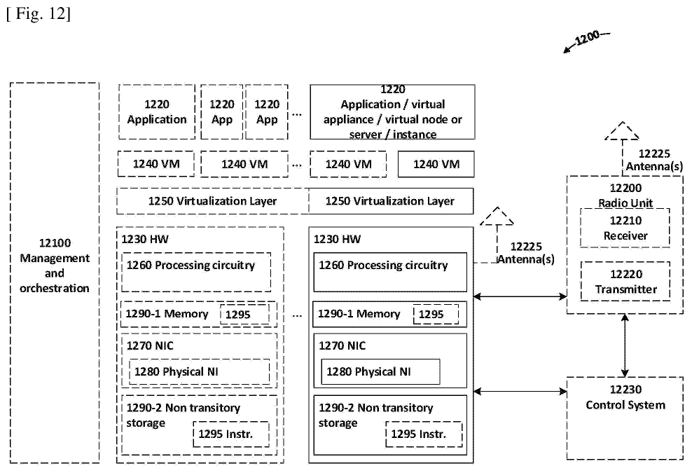

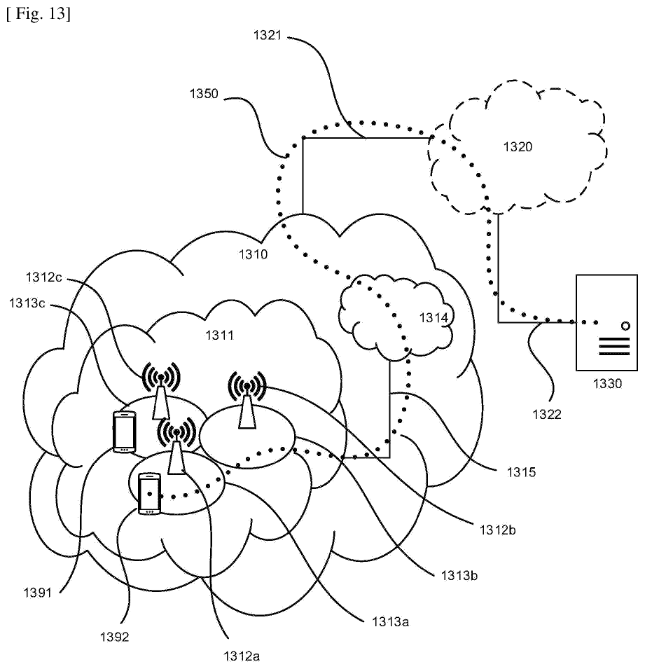

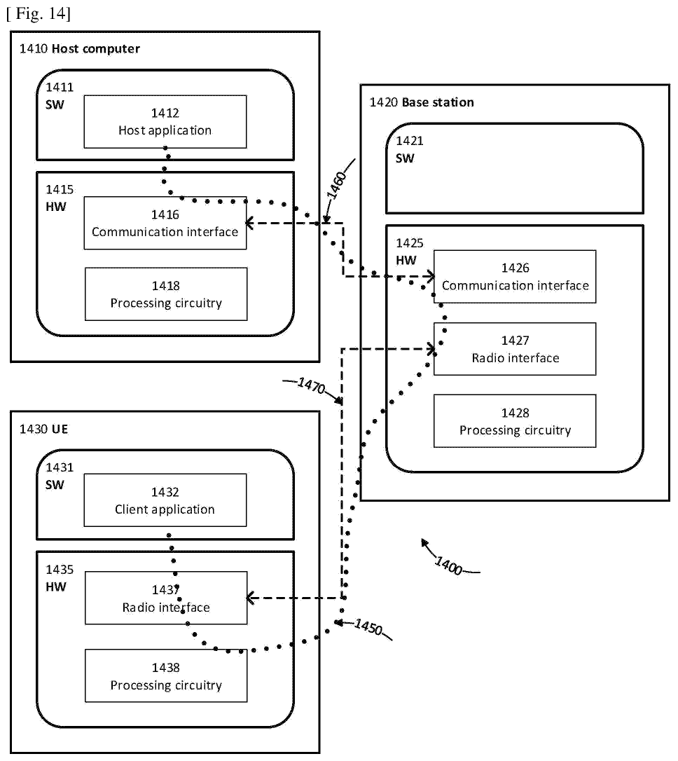

FIG. 12 is a schematic showing a virtualization environment in accordance with some embodiments.

FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290-1. Memory 1290-1 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

FIG. 13 is a schematic showing a telecommunication network connected via an intermediate network to a host computer in accordance with some embodiments.

With reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312a or 1312b or 1312c.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signalling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312a or 1312b or 1312c may not or need not be informed about the past routing of an incoming downlink communication with data originating from host computer 1330 to be forwarded (e.g., handed over) to a connected UE 1391. Similarly, base station 1312a or 1312b or 1312c need not be aware of the future routing of an outgoing uplink communication originating from the UE 1391 towards the host computer 1330.

FIG. 14 is a schematic showing a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 14. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 may be configured to facilitate connection 1460 to host computer 1410. Connection 1460 may be direct or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1330, one of base stations 1312a, 1312b, 1312c and one of UEs 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, some embodiments herein may enable the group message modification and group message cancellation over MBMS, MBS and MBS with interworking with MBMS. Some embodiments herein may fix the drawbacks within the current group message modification via MBMS (it is not workable to replace the group message using Update Session Properties to BM-SC). Some embodiments herein may improve the limitation with the current group message cancellation via MBMS (SCEF Terminate Session towards BM-SC but UE is not aware of the cancellation of the group message).

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signalling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

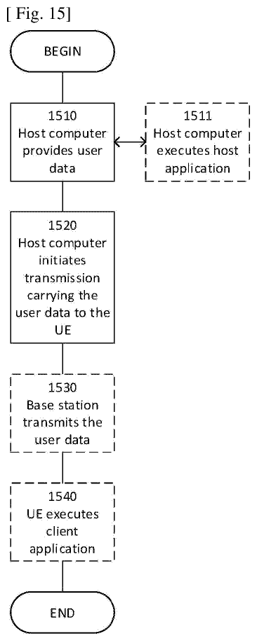

FIG. 15 is a schematic showing methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

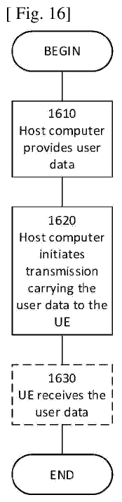

FIG. 16 is a schematic showing methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

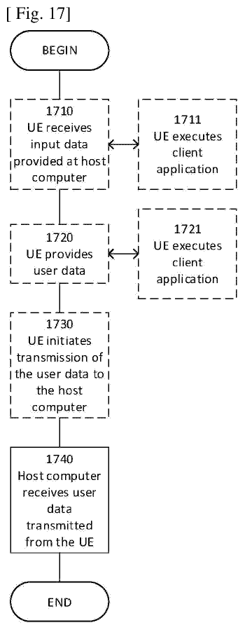

FIG. 17 is a schematic showing methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

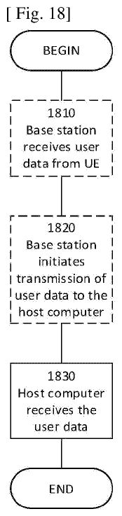

FIG. 18 is a schematic showing methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-57. (canceled)

58. A method performed by an exposure node, comprising:
receiving a group message request from an application node,
wherein when the group message request is for a modification of group message delivery and comprises group message payload, the method further comprises:
transforming the group message payload into a file; and
sending the file to a second broadcast multicast node, or
wherein when the group message request is for a cancellation of group message delivery, the method further comprises:
sending a first indication of a cancel of a file delivery to the third broadcast multicast node; or
sending an HTTP DELETE to the second broadcast multicast node to cancel file delivery.

59. The method according to claim 58, wherein determined file meta data is used as meta data information of the file; and/or
wherein the determined file meta data comprises a file uniform resource locator, URL and/or
a file uniform resource identifier, URI.

60. The method according to claim 58, wherein an ingest mode or object acquisition method is set to pull.

61. The method according to claim 58, wherein an ingest mode or object acquisition method is set to push.

62. The method according to claim 60, wherein when an ingest mode or object acquisition method is set to pull, sending the file to the second broadcast multicast node comprises:
sending a second indication of an update of the file to a third broadcast multicast node which will send a third indication based on the second indication to the second broadcast multicast node;
receiving a request for fetching the file from the second broadcast multicast node; and
sending a response comprising the file to the second broadcast multicast node;
wherein the second indication is a property or a parameter with a refresh or update value within session parameters to inform the second broadcast multicast node about the refresh of the file.

63. The method according to claim 61, wherein when an ingest mode or object acquisition method is set to push, sending the file to the second broadcast multicast node comprises:
pushing the file to the second broadcast multicast node; and/or
wherein the file is included in a file list.

64. The method according to claim 58, wherein the first indication is a property or a parameter with a cancel value to inform the second broadcast multicast node about cancel of file delivery.

65. The method according to claim 58, wherein the exposure node comprises at least one of:
a Network Exposure Function, NEF, or
a combined NEF and Service Capability Exposure Function, SCEF; and/or
wherein the second broadcast multicast node comprises a Multicast/Broadcast Service Transport Function, MBSTF; and/or

66. The method according to claim 58, wherein the group message request comprises a modify group message request with a requested action set to modify or cancel; and/or
wherein the group message request comprises a modify group message request or a cancel group message request.

67. A method performed by a second broadcast multicast node, comprising:
receiving a file from an exposure node or receiving an HTTP DELETE for canceling file delivery from the exposure node or receiving a first indication of a cancel of file delivery from a third broadcast multicast node, wherein the file is transformed from a group message payload and the group message payload is comprised in a group message request indicating a modification or cancellation of group message delivery from an application node to the exposure node.

68. The method according to claim 67, further comprising:
when receiving the file and a group message delivery hasn't started, encoding the file and using the file to replace an original file, wherein the file will be delivered after the group message delivery starts.

69. The method according to claim 67, further comprising:
when receiving the file and the group message delivery has started, encoding the file, stopping on-going group message delivery and starting a delivery of the file or starting the delivery of the file after the on-going group message is delivered.

70. The method according to claim 67, further comprising:
when receiving the first indication or the HTTP DELETE and the group message delivery has started, stopping file delivery and/or informing a multicast/broadcast service, MBS, client a cancellation of file delivery; and/or
wherein the cancellation is delivered in-band of an MBS session or out-band of the MBS session to at least one MBS client.

71. The method according to claim 67, further comprising:
when receiving the first indication or the HTTP DELETE and a group message delivery hasn't started, canceling file delivery and/or informing a multicast/broadcast service (MBS) client a cancellation of file delivery.

72. The method according to claim 67, wherein determined file meta data is used as meta data information of the file; and/or
wherein the determined file meta data comprises a file uniform resource locator, URL, and/or
a file uniform resource identifier, URI.

73. The method according to claim 67, wherein when an ingest mode or object acquisition method is set to pull, receiving the file from the exposure node comprises:
receiving a third indication based on a second indication of an update of the file from the third broadcast multicast node;
sending a request for fetching the file to the exposure node; and
receiving the file from the exposure node; and/or
wherein the second indication is a property or a parameter with a refresh or update value to inform the second broadcast multicast node about the refresh of the file.

74. The method according to claim 67, wherein when an ingest mode or object acquisition method is set to push, receiving the file from the exposure node comprises:
receiving the file pushed by the exposure node; and/or
wherein the file is included in a file list.

75. The method according to claim 67, wherein the exposure node comprises a NEF or a combined NEF and SCEF; and/or
wherein the second broadcast multicast node comprises an MBSTF; and/or
wherein the third broadcast multicast node comprises an MBSF.

76. The method according to claim 67, wherein the group message request comprises a modify group message request with a requested action set to modify or cancel; and/or
wherein the group message request comprises a modify group message request or a cancel group message request.

77. An exposure node, comprising:
a processor; and
a memory coupled to the processor, said memory containing instructions executable by said processor, whereby said exposure node is operative to:
receive a group message request from an application node,
wherein when the group message request is for a modification of group message delivery and comprises group message payload, the method further comprises:
transform the group message payload into a file; and
send the file to a second broadcast multicast node, or
wherein when the group message request is for a cancellation of group message delivery, the method further comprises:
send a first indication of a cancel of a file delivery to the third broadcast multicast node; or
send an HTTP DELETE to the second broadcast multicast node to cancel file delivery.
